(19) United States
(12) Patent Application Publication
(10) Pub. No.: US 2026/0329241 A1
(43) Pub. Date: Oct. 22, 2026

(54) METHODS AND SYSTEMS FOR REAL-TIME ADAPTIVE CONTROL OF INDUSTRIAL PROCESSES

(71) Applicant: Hexion Inc., Columbus, OH (US)

(72) Inventors: Michael LEFENFELD, Columbus, OH (US); Robert LAWTON, Columbus, OH (US); Zeru TEKIE, Columbus, OH (US); Jeffrey A. LINDEMAN, Columbus, OH (US); Gregory D. BRINER, Springfield, OR (US); Peter DEJONG, Springfield, OR (US); Robert B. CURRIE, Columbus, OH (US); Jeffrey R. BRUENING, Columbus, OH (US); Harden C. WREN, Diboll, TX (US); Daniel PACHECO, Springfield, OR (US); Ryan W. CLARKE, Springfield, OR (US); Sarath VEGA GUTIERREZ, Springfield, OR (US)

(73) Assignee: Hexion Inc., Columbus, OH (US)

(21) Appl. No.: 19/651,157

(22) Filed: Apr. 17, 2026

Related U.S. Application Data
(60) Provisional application No. 63/790,504, filed on Apr. 17, 2025.
(60) Provisional application No. 63/985,417, filed on Feb. 18, 2026.
(60) Provisional application No. 64/014,273, filed on Mar. 23, 2026.
(60) Provisional application No. 64/014,205, filed on Mar. 23, 2026.
(60) Provisional application No. 64/014,242, filed on Mar. 23, 2026.

(51) Int. Cl. G05B 13/04

(52) U.S. Cl. CPC G05B 13/042

(57) ABSTRACT

Methods and systems are disclosed for adaptive control of an industrial process in which an inherently variable feedstock is contacted with a formulation to produce a product. Measured information is acquired in real-time during operation of the industrial process and comprises at least one of a feedstock property, a process condition, or a product property, including direct measurements, indirect measurements, or both. The method determines, based on the measured information, at least one of a target formulation, a target process parameter adjustment, or a target feedstock adjustment and implements the determined target output during ongoing operation in a time frame effective to influence subsequently produced product.

### CROSS-REFERENCE TO RELATED APPLICATIONS

This application claims priority to and all benefit of U.S. Provisional Patent Application No. 63/790,504, filed Apr. 17, 2025, U.S. Provisional Patent Application No. 63/985,417, filed Feb. 18, 2026, U.S. Provisional Patent Application No. 64/014,242, filed Mar. 23, 2026, U.S. Provisional Patent Application No. 64/014,205, filed Mar. 23, 2026, and U.S. Provisional Patent Application No. 64/014,273, filed Mar. 23, 2026 the entire disclosure of each being incorporated herein by reference in its entirety.

### FIELD OF INVENTION

The invention relates generally to methods for real-time adaptive control of industrial processes in which an inherently variable feedstock is contacted with a formulation to produce a product. More particularly, the invention relates to determining and implementing, during operation of the industrial process, one or more of a target formulation, a target process parameter adjustment, or a target feedstock adjustment based on measured feedstock properties, measured process conditions, and/or measured product properties. Systems configured to carry out such methods are also disclosed.

### BACKGROUND

Industrial processes in which a feedstock is contacted with a formulation to produce a product often depend on a stable relationship among feedstock condition, formulation behavior, and process conditions. In many such processes, however, the feedstock is inherently variable, meaning that the feedstock may vary in physical, chemical, mechanical, and/or compositional properties as a result of source-to-source differences, temporal fluctuations, environmental exposure, storage history, biological heterogeneity, recycled-content variation, or upstream processing history. Where the feedstock is inherently variable, the same formulation and the same process settings can produce different process behavior and different product outcomes at different times during operation.

Conventional manufacturing systems are often designed around fixed formulations and relatively static process windows. In many cases, process control assumes that feedstock variation can be reduced upstream, tolerated within a predetermined operating range, or addressed through occasional manual adjustments. In practice, however, variation in the feedstock can alter formulation uptake, distribution, penetration, reaction rate, cure behavior, interfacial interactions, energy demand, densification behavior, and other process-relevant phenomena in ways that are not adequately addressed by fixed recipes or infrequent operator intervention. As a result, feedstock variability can propagate through the process and appear as variability in throughput, efficiency, cure state, dimensional stability, bond performance, moisture resistance, emissions, or other product properties.

This problem is particularly acute where the feedstock exhibits variability in compositional properties that are not fully captured by conventional monitoring of physical conditions alone. A feedstock can present substantially similar moisture content, temperature, or bulk density while differing in chemical state in a manner that materially affects interaction with the formulation. Such compositional variability can shift the effective processing environment encountered by the formulation and thereby change the process conditions required to achieve acceptable and consistent product performance. In these circumstances, a formulation or process condition set that performs adequately for one feedstock state may perform inadequately when the feedstock state changes during ongoing operation.

The manufacture of engineered wood products is one example that illustrates this problem. Wood furnish is an inherently variable feedstock that can vary in species composition, extractives content, pH, buffer capacity, moisture content, density, porosity, particle size, particle-size distribution, flake form, strand geometry, fines content, drying history, storage history, upstream processing history, season, or combinations thereof. Such variation may materially affect adhesive wetting, penetration, cure kinetics, bond-line formation, densification behavior, and final panel properties. More generally, similar issues arise in other industrial processes in which a feedstock is contacted with a formulation and the relevant properties of the feedstock vary during operation and influence the interaction between the formulation and the feedstock.

Existing approaches do not fully address this problem. In some operations, formulations are supplied as fixed products whose key behavioral characteristics are determined before use and are not materially adapted during production. In other operations, selected process parameters may be adjusted based on historical experience, periodic quality testing, or broad operating rules, but not in coordinated response to measured variation in the feedstock, the process, and the resulting product. In still other cases, measurements may be available, but the measured information is not used to determine whether the more effective corrective action lies in adjusting the formulation, adjusting one or more process parameters, adjusting the feedstock presented to the process, or adjusting a combination thereof during operation of the industrial process.

Accordingly, a need exists for methods and systems capable of adaptively controlling an industrial process in which a formulation is contacted with an inherently variable feedstock to produce a product. A further need exists for methods and systems that use measured feedstock properties, measured process conditions, and measured product properties to determine and implement, during operation of the industrial process, one or more of a target formulation, a target process parameter adjustment, or a target feedstock adjustment so that manufacturing performance can be made more consistent despite variation in the feedstock.

### SUMMARY

The invention relates to methods for adaptively controlling an industrial process in which an inherently variable feedstock is contacted with a formulation and processed to produce a product. During ongoing operation of the industrial process, measured information including one or more feedstock properties, process conditions, product properties, or combinations thereof is used to determine and implement at least one adjustment effective to influence subsequently produced product. The adjustment can comprise a target formulation, a target process parameter adjustment, a target feedstock adjustment, or a coordinated combination thereof. In this manner, the disclosed methods enable manufacturing performance to remain responsive to variation in feedstock state during production rather than relying solely on a fixed formulation or preselected operating condition.

In various aspects, the invention relates to a method of manufacturing a product from an inherently variable feedstock. The method comprises introducing the inherently variable feedstock into an industrial process, the inherently variable feedstock exhibiting variation in composition over time; measuring during operation at least one of a feedstock property, a process condition, or a product property; determining, based on the at least one measured feedstock property, process condition, or product property, at least one of a target formulation, a target process parameter adjustment, or a target feedstock adjustment; and implementing at least one of the target formulation, the target process parameter adjustment, or the target feedstock adjustment during ongoing operation of the industrial process in a time frame effective to influence subsequently produced product. The measured feedstock property may comprise a compositional property indicative of chemical composition, species identity, anatomy, age, extractives content, buffer capacity, or combinations thereof. The measured information may include direct measurements, indirect measurements, or both. Upstream measurements may be used to provide a feedforward adjustment, downstream measurements may be used to provide a feedback adjustment, and at least two of the target formulation, the target process parameter adjustment, and the target feedstock adjustment can be implemented in coordination with one another.

A target formulation may be prepared by adjusting one or more formulation ingredients at or near a point of use to form an adjusted formulation. The formulation may be adjusted from a plurality of standardized components, for example including a first standardized adhesive composition comprising a higher-average-molecular-weight resin fraction and a second standardized adhesive composition comprising a lower-average-molecular-weight resin fraction, which can be blended in a blend ratio determined from the measured feedstock property, process condition, or product property.

A target process parameter adjustment may include adjustment of one or more operating parameters selected from temperature, pressure, line speed, residence time, application rate, mixing intensity, curing conditions, drying conditions, moisture target, and combinations thereof.

A target feedstock adjustment may include moisture conditioning, source selection, source blending, pre-treatment application, or a combination thereof implemented at or upstream of a point of contact between the inherently variable feedstock and the formulation.

The disclosed methods can be applied in a variety of industrial processes in which an inherently variable feedstock is contacted with a formulation and then processed to produce a product. Exemplary use cases include manufacture of wood-based composites, lignocellulosic composite products, fiber-based composite products, mineral-or particulate-filled composite products, recycled-material composite products, coated substrates, impregnated substrates, bonded mats, molded products, pressed products, and other materials systems in which variation in feedstock composition, moisture state, surface condition, geometry, porosity, or another feedstock property can affect formulation behavior, process behavior, product formation, or resulting product performance. One particularly useful implementation is manufacture of engineered wood products, discussed further below.

Also disclosed is a method of manufacturing an engineered wood product from an inherently variable wood furnish and a wood adhesive. The method comprises introducing the wood furnish into a manufacturing process; measuring during operation at least one of furnish moisture content, furnish extractives indicator, furnish pH, furnish buffer capacity, adhesive gel time, mat moisture content at press entry, dielectric response, internal bond strength, thickness swell, emissions, water absorption, water resistance, density, density profile, screw holding capacity, particle geometry, delamination resistance, thickness, thickness variation, defects, modulus of rupture, modulus of elasticity, mat weight, mat uniformity, and particle size distribution; determining, based on the at least one measured value, at least one of a target wood adhesive, a target press parameter adjustment, or a target wood furnish adjustment; implementing at least one of the target wood adhesive, the target press parameter adjustment, or the target wood furnish adjustment during operation of the manufacturing process; contacting the wood furnish with the wood adhesive; and consolidating the wood furnish and the wood adhesive under heat and pressure to produce the engineered wood product.

Further disclosed is a system configured to carry out the foregoing methods. The system comprises one or more measurement devices configured to measure at least one of a feedstock property, a process condition, or a product property during operation of the industrial process; a control module configured to receive the measured information and determine, based thereon, at least one of a target formulation, a target process parameter adjustment, or a target feedstock adjustment; formulation-adjustment equipment configured to implement the target formulation; process control equipment configured to implement the target process parameter adjustment; and feedstock-adjustment equipment configured to implement the target feedstock adjustment during operation of the industrial process. The system determines a target output by selecting a validated adjustment from a plurality of validated adjustments or by interpolating between validated adjustments. In engineered wood manufacture, the system may be configured to direct different target formulations, different target feedstock adjustments, different target process parameter adjustments, or combinations thereof to different layers of a product so as to provide a zoned or gradient product architecture.

### BRIEF DESCRIPTION OF DRAWINGS

FIG. 1 is a block diagram illustrating a method of adaptively controlling an industrial process in which measured information is used during ongoing operation to determine and implement a target formulation, a target process parameter adjustment, a target feedstock adjustment, or a coordinated combination thereof to produce a product from an inherently variable feedstock.

FIG. 2 graphically illustrates buffer capacity of Douglas Fir, white oak, and blends of Douglas-fir and white oak at different proportions according to Example 1.

FIG. 3 graphically illustrates the buffer capacity of Douglas Fir as a function of its content (%) according to Example 1.

FIG. 4 graphically illustrates the cure peak temperature versus percent catalyst according to Example 2.

FIG. 5 is a graph showing FT-mIR spectra of OSB flakes at moisture contents of 4% and 8% according to Example 8.

### DETAILED DESCRIPTION

The invention relates to methods for real-time adaptive control of industrial processes in which an inherently variable feedstock is contacted with a formulation to produce a product. The methods include introducing the inherently variable feedstock into the industrial process, measuring during operation at least one of a feedstock property, a process condition, or a product property, determining from the measured information at least one of a target formulation, a target process parameter adjustment, or a target feedstock adjustment, and implementing the determined target output during ongoing operation in a time frame effective to influence subsequently produced product. As used herein, “target output” refers to a target formulation, a target process parameter adjustment, a target feedstock adjustment, or a combination thereof. The methods are particularly useful where the feedstock exhibits inherent variability on a timescale relevant to operation of the industrial process.

The measured information can include direct measurements of properties of interest and indirect measurements indicative of feedstock condition, process behavior, or product performance. The methods can use upstream measurements to provide a feedforward adjustment, downstream measurements to provide a feedback adjustment, or both, and can operate continuously, semi-continuously, in batch mode, or in a hybrid process. Depending on the detected condition, the methods can implement a target formulation, a target process parameter adjustment, a target feedstock adjustment, or a coordinated combination thereof so that the process responds to feedstock-driven variability while the relevant production interval remains actionable.

The disclosed methods can be carried out using one or more systems configured to acquire measured information, determine a target output, and implement the target output during operation of the industrial process. Such systems can include one or more measurement devices, a control module, and one or more implementation subsystems configured to carry out formulation adjustments, process parameter adjustments, feedstock adjustments, or combinations thereof. Accordingly, the system architecture described herein provides one example of hardware, software, and control infrastructure by which the disclosed methods can be carried out in practice.

Although certain examples herein relate to engineered wood manufacturing processes, the methods are not limited to engineered wood manufacturing and may be applied in other industrial processes in which an inherently variable feedstock is contacted with a formulation and variation in the feedstock influences process behavior, product formation, or product properties.

In industrial processes in which an inherently variable feedstock is contacted with a formulation to produce a product, consistent operation can be difficult to achieve with the variability in feedstock composition or process condition. In particular, variation in a feedstock may occur not only in physical attributes, but also in compositional or chemical characteristics that affect formulation uptake, distribution, penetration, reaction behavior, cure progression, interfacial interactions, and resulting product properties. As a result, a formulation and operating condition set that performs acceptably under one feedstock condition may perform differently when the feedstock changes during production. Conventional reliance on fixed formulations, static process windows, or infrequent adjustments may permit feedstock-driven variability to propagate through the process, leading to inconsistency in throughput, cure state, bond performance, dimensional stability, emissions, or other performance measures. In addition, even where measurements are available, such information is not consistently used in a real-time, coordinated manner to determine whether a more effective response lies in adapting the formulation, adapting one or more process parameters, adapting the feedstock presented to the process, or adapting a combination thereof while production is ongoing.

The invention addresses these technical problems through a real-time adaptive method in which one or more measured feedstock properties, one or more measured process conditions, and/or one or more measured product properties are used to determine and implement one or more adjustments during operation of the industrial process. The measured information can include direct measurements of properties of interest and/or indirect measurements that are indicative of feedstock condition, process behavior, or product performance on the timescale of the industrial process. Based on the measured information, the method determines at least one of a target formulation, a target process parameter adjustment, a target feedstock adjustment, or a combination thereof, and implements the determined adjustment so that the process responds to detected variation while the relevant production interval remains actionable. In this manner, the disclosed methods can provide feedforward control, feedback control, or coordinated feedforward-and-feedback control, thereby enabling adaptation to variable feedstock conditions and more consistent manufacturing performance without reliance on a fixed recipe or a pre-selected batch setting.

As used herein, “real-time” refers to a period during ongoing operation of an industrial process, within a time frame that permits an implemented adjustment to affect the same production run or an immediately subsequent production run associated with the measurement from which the adjustment was determined. Real-time operation does not require instantaneous measurement, determination, or implementation, but instead refers to operation within a time frame relevant to the industrial process and sufficiently responsive to feedstock variability, process variability, product variability, or combinations thereof.

An “industrial process” is a process in which a feedstock is contacted with a formulation and processed to produce a product.

A “feedstock” is a raw material, substrate, or starting material that is contacted with the formulation in the industrial process.

An “inherently variable feedstock” is a feedstock whose properties, composition, or condition vary due to source variation, environmental exposure, process history, storage conditions, geographic or biological heterogeneity, recycling or reuse streams, or temporal fluctuations within the industrial process.

A “feedstock property” refers to a property, characteristic, state, composition, condition, or other attribute of the feedstock that may be measured directly or indirectly.

A “process condition” refers to a measurable state, parameter, or condition associated with operation of the industrial process.

A “product property” refers to a measurable property, characteristic, or performance attribute of a product produced by the industrial process, including an intermediate product, an in-process product state, or a finished product.

Unless otherwise indicated by the context, singular terms include the plural and plural terms include the singular. The terms “comprising,” “including,” “having,” and similar terms are intended to be open-ended and do not exclude additional elements, steps, or features. The terms “first,” “second,” and similar relational terms are used only to distinguish one element, state, source, or step from another and do not require a particular order, priority, or numerical limitation. Numerical values, ranges, and parameters may vary within manufacturing tolerances, measurement tolerances, and other practical limits consistent with the disclosed subject matter. Endpoints of disclosed ranges are inclusive unless the context indicates otherwise. All such variations and modifications are intended to be within the scope of the present disclosure.

### Methods for Real-Time Adaptive Control of Industrial Processes

The invention is directed to methods for real-time adaptive control of industrial processes in which an inherently variable feedstock is introduced into an industrial process, contacted with a formulation, and processed to produce a product, while measured information is continuously or periodically used to determine and implement one or more adjustments during ongoing operation of the industrial process. The methods can be carried out as a continuous process, a semi-continuous process, a batch process, or a hybrid process. In each case, the methods may be carried out on a timescale effective for variation in the inherently variable feedstock, the industrial process, the product, or a combination thereof to be detected and used in determining and implementing a target formulation, a target process parameter adjustment, a target feedstock adjustment, or a combination thereof before a relevant production interval is no longer actionable.

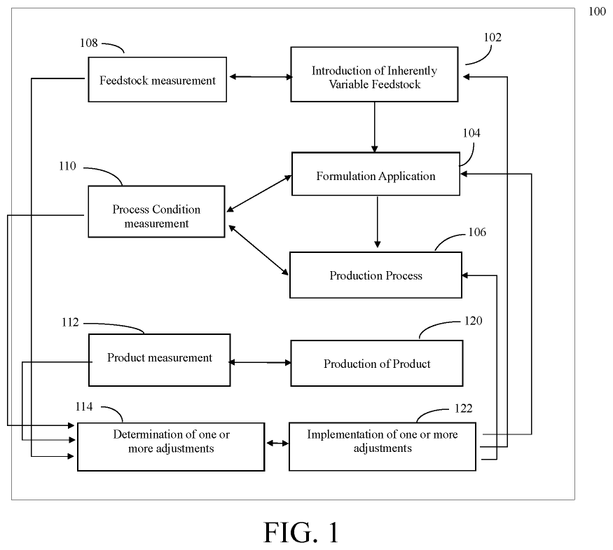

An exemplary method for real-time adaptive control of an industrial process 100 is illustrated in FIG. 1. As shown, one or more inherently variable feedstock sources provide a feedstock to the industrial process 100 at stage 102, and the feedstock is contacted with a formulation at a formulation application stage 104 and thereafter processed at one or more processing stages 106 to produce a product 120. During ongoing operation, measured information is obtained and can include one or more feedstock properties 108, one or more process conditions 110, one or more product properties 112, or combinations thereof associated with the feedstock sources 102, the formulation application stage 104, the processing stages 106, the product production stage 120, or multiple locations along the industrial process 100. Based on the measured information, the method includes a determination step 114 in which it is determined whether an adjustment is to be implemented and, if so, whether the adjustment comprises a target formulation, a target process parameter adjustment, a target feedstock adjustment, or a coordinated combination thereof. The determined adjustment is implemented at stage 122, during ongoing operation in a time frame effective to influence subsequently produced product, and additional measured information can be used in a monitoring and feedback loop to evaluate the effect of the implemented adjustment and to support later determinations during successive production intervals.

As introduced above, an inherently variable feedstock is introduced into the industrial process from one or more feedstock sources in step 102. The inherently variable feedstock may exhibit variation over time, between sources, between lots, between batches, between portions of a feedstock stream, or combinations thereof. The feedstock is contacted with a formulation at one or more application stages 104 and can thereafter be subjected to one or more processing stages 106 configured to convert the inherently variable feedstock and the formulation into an intermediate product or a finished product 120. The industrial process 100 may include additional process steps such as transport, blending, deposition, mixing, shaping, drying, heating, pressing, curing, cooling, finishing, packaging, or other operations. Because the inherently variable feedstock can change during ongoing operation of the industrial process, a formulation or process setting that is suitable for one feedstock state can be less suitable for a later-occurring feedstock state.

During operation of the method, one or more feedstock properties 108, one or more process conditions 110, one or more product properties 112, or combinations thereof are measured. The measured information may be obtained upstream of contact between the inherently variable feedstock and the formulation, during one or more stages in which the inherently variable feedstock and the formulation are being processed, downstream of a main processing stage, or at multiple locations along the industrial process. The measured information may include direct measurements of one or more properties and indirect measurements indicative of one or more properties or states of interest. An indirect measurement can include a measured signal correlated with, predictive of, or otherwise informative of a feedstock property, a process condition, or a product property even where the relevant property is not itself directly sensed. Examples of indirect measurements include spectral information used to estimate species composition, chemical class, extractives content, or another compositional state of a feedstock; pH used as an indicator of a likely chemical environment or interaction state between the feedstock and the formulation; dielectric response used to indicate cure progression or reaction state; temperature-profile information used to indicate reaction condition, cure condition, or heat-transfer condition; and optical or image-based information used to infer geometry, fines content, or another morphology-related property. In this manner, a measured signal can be used to determine a control-relevant feature even where the corresponding property is not directly measured.

The measured information may be obtained from, for example, in-line sensors, near-line sensors, laboratory systems, sampled-product testing, operator inputs, quality databases, plant information systems, enterprise systems, maintenance records, production schedules, raw-material records, supplier data, environmental monitoring systems, forecast data sources, or combinations thereof. Such measured information may include, by way of example, compositional information such as species composition, extractives content, pH, buffer capacity, contaminant level, ash content, recycled-content composition, or combinations thereof; physical or structural information such as moisture content, temperature, density, porosity, particle size, particle-size distribution, shape, geometry, thickness, density profile, or combinations thereof; feedstock-history information such as storage condition, upstream processing history, or combinations thereof; process-condition information such as pressure, flow rate, line speed, residence time, mixing intensity, formulation application rate, drying condition, curing condition, compaction condition, energy consumption, motor load, torque, vibration, humidity, ambient condition, or combinations thereof; product-property information such as cure state, bond performance, internal bond strength, dimensional stability, thickness swell, water absorption, moisture resistance, surface quality, emissions, color, gloss, strength, modulus, or combinations thereof; and indirect or response-based information such as dielectric response, thermal response, acoustic response, or combinations thereof. The measured information can be normalized, timestamped, correlated, filtered, fused, transformed, or otherwise processed to generate one or more control-relevant features.

The method may utilize measured information acquired at multiple timescales, wherein different classes of measurements are assigned distinct functional roles within a coordinated control architecture. For example, high-frequency in-line measurements may be used for time-sensitive determinations and immediate control actions affecting material currently being processed. Near-line measurements may be used to verify trends, update a current process state, or confirm inferred conditions used in control decisions. Lower-frequency off-line, laboratory, or historical measurements may be used to recalibrate models, validate correlations, update validated operating ranges, and update a library of validated control states or validated adjustments.

In this manner, the method integrates real-time, near-real-time, and historical information across multiple timescales, wherein faster measurements support immediate control decisions and slower measurements support model refinement, state validation, and improvement of subsequent control determinations. The method thereby operates as a multi-timescale adaptive system in which control actions applied during ongoing operation are informed by both current measured conditions and accumulated knowledge derived from prior production intervals.

Based on the measured information, the next step is determining whether an adjustment is to be implemented 114 and, if so, whether the adjustment comprises a target formulation, a target process parameter adjustment, a target feedstock adjustment, or a coordinated combination thereof. A target formulation can be determined where the measured information indicates that interaction between the inherently variable feedstock and the formulation has shifted away from a target state. A target process parameter adjustment can be determined where the measured information indicates that process timing, temperature, pressure, residence time, drying conditions, curing conditions, or another operating parameter is to be adjusted. A target feedstock adjustment can be determined where the measured information indicates that the state of the inherently variable feedstock presented to the process is to be changed by source selection, source blending, conditioning, pretreatment, classification, routing, or another feedstock-directed action. In some cases, at least two of the target formulation, the target process parameter adjustment, and the target feedstock adjustment are implemented in coordination with one another. In other instances, all three adjustments are implemented in coordination with one another.

The determination of an adjustment may be augmented using one or more predetermined rules, correlations, empirical relationships, response surfaces, statistical models, mechanistic models, machine-learning models, optimization routines, historical operating regimes, validated operating ranges, validated control states, validated process recipes, validated formulation states, validated feedstock adjustment states, or combinations thereof. A target formulation, a target process parameter adjustment, a target feedstock adjustment, or a combination thereof can be determined by selecting a validated control state from a plurality of validated control states or by interpolating between validated control states. Where multiple candidate adjustments are available, the method can further include selecting among the candidate adjustments based on predicted effect on product consistency, predicted effect on process stability, implementation latency, material constraints, safety constraints, confidence level, or combinations thereof. A candidate adjustment can be evaluated to determine whether the candidate adjustment is within a validated operating range before implementation. In some cases, a confidence value is assigned to a candidate adjustment and the candidate adjustment is automatically implemented when the confidence value satisfies a threshold. In other cases, implementation can be deferred, a hold condition can be maintained, or operator review can be requested when the confidence value does not satisfy a threshold or when a candidate adjustment falls outside a validated operating range.

Once an adjustment is determined, the method implements the one or more adjustments during operation of the industrial process 122. In some aspects, a target formulation may be implemented by adjusting one or more formulation components, ingredient ratios, additive levels, catalyst levels, solids levels, viscosities, or other formulation characteristics at or near a point of use. A target formulation comprises a determined formulation state to be implemented before or at the time the variable feedstock is contacted with the formulation. The target formulation can include, for example, selection of one or more formulation recipes, adjustment of a blend ratio among formulation components, adjustment of an additive dosage, adjustment of catalyst loading, adjustment of solids content, adjustment of viscosity, adjustment of sequence or timing of addition, or another formulation-related change. The target formulation can be determined from measured feedstock properties, measured process conditions, measured product properties, or combinations thereof and can be implemented on a timescale effective to influence subsequently produced product during ongoing operation of the industrial process.

In some examples, the formulation is not supplied only as a fixed finished product, but instead is assembled, blended, or modified at or near a point of use from a plurality of standardized components. The standardized components can include, for example, different resin compositions, different polymer-containing streams, different catalyst-containing streams, different curative-containing streams, different additive-containing streams, different modifier-containing streams, different solvent or diluent streams, different carrier streams, different scavenger-containing streams, different surfactant-containing streams, different hydrophobe-containing streams, or combinations thereof. The method can accordingly determine not only that a formulation adjustment is to be made, but also which standardized components are to be used and in what proportions to produce the target formulation for the currently detected process state.

The target formulation can further include one or more blending-process variables used in preparing the formulation at or near a point of use. Such blending-process variables can include order of addition, stage of addition, degree of mixing, mixing intensity, residence time, recirculation condition, component temperature, hold time, or combinations thereof. Two or more sub-blends can be formed separately and combined in a later stage, and one or more reactive components can be withheld until a final mixing stage immediately before application so that storage stability and application-stage reactivity can be separately controlled. In this manner, the target formulation may comprise not only a selected composition, but also a selected blending sequence or formulation-preparation state.

The target formulation may further comprise a target formulation architecture in which one or more standardized components are selected and combined so as to define not only formulation composition but also physical organization or activation behavior of the resulting formulation. As used herein, “formulation architecture” refers to the structural, compositional, and functional organization of a formulation that governs its behavior during processing and end use. Formulation architecture encompasses the identity and relative amounts of formulation ingredients and also the manner in which such ingredients are organized, interact, and contribute to system performance, including whether the formulation is provided as a solution, dispersion, emulsion, suspension, powder, or multiphase system.

For example, one or more standardized components can be provided as separate phases, dispersed reactive domains, encapsulated components, emulsions, suspensions, or combinations thereof, and the method can determine a target state in which one or more reactive components remain separated or protected until exposed to a selected trigger condition. The trigger condition can comprise heat, moisture, pressure, shear, pH change, or another process condition encountered during manufacture. The method can thereby determine a formulation architecture associated with staged activation, staged cure behavior, altered transport behavior, or altered network formation as compared with a formulation in which all components are fully combined before application.

The method may further determine a transition strategy between a first formulation state and a second formulation state during ongoing production. The transition strategy can include a ramped change, a staged blend change, an intermediate formulation state, a purge composition, or another transition condition selected to manage residual material within lines, manifolds, or mixing volume during changeover. Product produced during a transition interval can be associated with the corresponding transition state and can be separately identified, classified, routed, or evaluated if desired.

The target formulation can be determined using one or more rules, correlations, empirical models, mechanistic models, artificial intelligence models, machine-learning models, response surfaces, validated formulation states, validated control states, historical operating relationships, or combinations thereof. The target formulation can be selected from a plurality of validated formulation states or can be determined by interpolation between validated formulation states. The target formulation can be implemented independently or in coordination with a target process parameter adjustment, a target feedstock adjustment, or both.

A target formulation may include two or more formulation components from separate sources at an adjusted blend ratio, additive level, catalyst level, solids level, or the target formulation may adjust a viscosity-modifying input, sequence of addition, or another formulation variable to generate the target formulation for contact with the inherently variable feedstock. The implementation of a formulation adjustment may occur on a timescale effective to influence subsequently produced products while the process continues to operate.

A target process parameter adjustment may be implemented by changing one or more process setpoints or operating parameters of the industrial process. The target process parameter adjustment may comprise an adjustment to temperature, pressure, flow rate, line speed, residence time, mixing condition, drying condition, curing condition, moisture target, application rate, or another process parameter that influences interaction between the formulation and the inherently variable feedstock or influences formation of the product. The process parameter adjustment may be operated independently of the formulation-adjustment and/or feedstock-adjustment, or it may be operated in coordination.

The target process parameter adjustment may be determined and implemented in a manner effective to maintain acceptable product quality while reducing formulation demand, reducing adhesive usage, improving manufacturing efficiency, increasing productivity, or combinations thereof. For example, one or more process parameters selected from temperature, pressure, line speed, residence time, application rate, mixing intensity, curing condition, drying condition, moisture target, compaction condition, or combinations thereof can be adjusted so that interaction between the formulation and the inherently variable feedstock is improved, bond development is maintained or improved, cure behavior is maintained or improved, or product formation is made more consistent, thereby permitting a lower formulation loading than would otherwise be used under the detected operating condition or permitting increased throughput while avoiding unacceptable loss of product quality. In some cases, measured process conditions, measured product properties, or both indicate that a current formulation loading can be reduced while one or more quality metrics remain within a validated operating window. In other cases, the method determines that restoration or modification of one or more process conditions is preferred to increasing formulation loading, so that acceptable product quality is maintained without unnecessary formulation escalation.

A target feedstock adjustment may be implemented by changing a feedstock source, a feedstock blend, a conditioning step, a pretreatment step, or another aspect of the inherently variable feedstock before or during contact with the formulation. The target feedstock adjustment may include, for example, source selection, source blending, moisture conditioning, size classification, routing, storage selection, pH adjustment, buffer-capacity modification, pretreatment application, or another change directed to the inherently variable feedstock itself. The target feedstock adjustment may occur at a position upstream of a point at which the inherently variable feedstock is contacted with the formulation so that the feedstock state presented to the process can be changed before the formulation is applied. The target feedstock adjustment may be implemented as an independent adjustment, or may be implemented in coordination with a target formulation adjustment, a target process parameter adjustment, or both.

In certain operating modes, a feedstock adjustment may serve as a primary adaptive control pathway while formulation composition, major process settings, or both are held substantially constant or maintained within a selected operating window. In such cases, the method responds to detected variation by changing the state of the feedstock presented to the process rather than primarily relying on reformulation or downstream process correction. This mode can be useful where a selected formulation state remains suitable over a defined range and product consistency can be improved by maintaining the feedstock within a target feedstock state or target feedstock range before contact with the formulation.

The target feedstock adjustment may comprise a coordinated feedstock adjustment architecture including identity, magnitude, sequence, and timing of two or more upstream feedstock-directed changes selected to produce a more consistent feedstock state at a formulation-contact stage. The coordinated feedstock adjustment architecture may include, for example, source selection, source blending, moisture conditioning, temperature conditioning, classification, screening, refining, routing, storage selection, fines management, geometry control, pretreatment, or combinations thereof. The method can therefore determine not only that a feedstock adjustment is to be implemented, but also which feedstock-directed changes are to be combined, in what sequence, and on what timing so that the intended portion of feedstock is presented to the formulation under a more consistent condition.

Feedstock adjustment may further include control of upstream preparation variables associated with furnish geometry, fines content, surface area, permeability, or other feedstock attributes influencing interaction with the formulation. For example, the method can determine an adjustment to refining conditions, refiner gap, screening conditions, classification conditions, screen size, source-blend ratio, or another upstream preparation variable so as to change particle geometry, flake form, fiber form, fines content, density distribution, porosity, or related feedstock characteristics. Finer geometry can increase surface area and fines content and thereby influence formulation distribution, penetration behavior, and formulation demand, while coarser geometry can reduce surface area and can alter permeability, densification behavior, and processing behavior. Measured process conditions, measured product properties, or both can therefore be used to determine an upstream feedstock-preparation adjustment effective to improve later product formation and product performance.

The target feedstock adjustment may further include screening, sieving, classification, fines management, geometry control, refining adjustment, refiner-gap adjustment, source selection, source blending, routing, or combinations thereof effective to remove fines, reduce an excessive fines fraction, improve particle geometry, improve fiber form, improve strand geometry, narrow a geometry distribution, reduce excess surface area, or otherwise bring the feedstock toward a target feedstock state associated with reduced formulation demand, improved distribution of the formulation, improved penetration behavior, improved densification behavior, improved process stability, improved productivity, or improved product consistency. For example, where measured information indicates that increased fines content, less favorable geometry, or greater effective surface area is contributing to increased adhesive demand or inconsistent product formation, the method can determine and implement an upstream feedstock-preparation adjustment directed to screening or other classification-based correction before the feedstock is contacted with the formulation. In this manner, the target feedstock adjustment can be used not only to correct a quality deviation, but also to reduce formulation demand, maintain acceptable product quality at a lower adhesive loading, improve throughput, or combinations thereof.

Implementation timing can be determined with reference to transport delay, equipment latency, mixing delay, residence time, line position, or another temporal or positional factor so that the adjustment influences an intended portion of subsequently produced product. The process may further determine a transition strategy between operating states, including a ramped change, a staged implementation, an intermediate setpoint, an intermediate blend state, a purge condition, or another transition condition configured to manage changeover during ongoing production.

The method may further include monitoring the effect of an implemented adjustment. After implementation of a target formulation, a target process parameter adjustment, a target feedstock adjustment, or a coordinated combination thereof, one or more downstream measurements can be used to evaluate whether the implemented adjustment moved the industrial process, the product, or both toward a target state. Upstream measurements can be used to provide a feedforward adjustment, downstream measurements can be used to provide a feedback adjustment, and the method can operate in a feedforward mode, a feedback mode, or a coordinated feedforward-and-feedback mode. One or more measured product properties can be associated with corresponding upstream feedstock states, formulation states, and process states using timestamps, line position, residence time, batch identity, lot identity, or other synchronization information. The method can further include evaluating one or more measured product properties over a rolling production window using statistical process control, trend detection, model-based estimation, or combinations thereof to determine whether the product is trending toward an out-of-specification condition before a specification limit is reached. Based on the measured outcomes associated with previously implemented adjustments, the method may update a model, a rule set, a validated control state library, a correlation, or another decision resource so that later determinations become better matched to recurring states of the inherently variable feedstock, the industrial process, the product, or any combination thereof.

After a target formulation, a target process parameter adjustment, a target feedstock adjustment, or a coordinated combination thereof is determined and implemented, the feedstock and the formulation are processed to produce a product 120. The feedstock and the formulation can be conveyed, blended, deposited, mixed, shaped, dried, heated, pressed, cured, cooled, finished, packaged, or otherwise processed through one or more downstream operations effective to convert the feedstock and the formulation into an intermediate product or a finished product. In this manner, the disclosed method includes not only determining and implementing an adjustment responsive to measured information, but also producing the resulting product from the adjusted feedstock state, formulation state, process state, or coordinated combination thereof.

The method can be repeated continuously or iteratively across successive production intervals so that control decisions remain responsive to variation in the inherently variable feedstock during ongoing operation of the industrial process. Transitions in feedstock state may be tracked over time and implementation of adjustments may be synchronized to the changing position of corresponding material within the industrial process. Different adjustments can be directed to different portions of a product, different layers of a product, different zones of a process, or different intervals of production.

The method may incorporate software and/or artificial intelligence during operation of the industrial process to transform measured information into one or more control-relevant features and to determine a target formulation, a target process parameter adjustment, a target feedstock adjustment, or a coordinated combination thereof. The artificial intelligence can use one or more rules-based models, first-principles models, statistical models, machine learning models, neural networks, reinforcement learning models, digital twin models, model predictive control routines, optimization routines, expert systems, or combinations thereof to map measured and/or predicted inputs to one or more target outputs. The measured and/or predicted inputs can include feedstock properties, process conditions, product properties, environmental conditions, equipment-state information, historical operating information, operator inputs, or combinations thereof. In this manner, the method can use artificial intelligence not only to respond to measured variability, but also to predict a later process condition, product condition, or feedstock-response condition and determine an adjustment before a quality deviation occurs.

The method can further include using artificial intelligence to perform one or more of feedstock classification, anomaly detection, sensor fusion, missing-data estimation, soft sensing of an unmeasured property, prediction of one or more downstream product properties, forecasting of environmental or process disturbances, recommendation of an adjustment, confidence scoring, constrained optimization within a validated operating envelope, or combinations thereof. The method can include determining whether current measured information corresponds to a previously validated operating state, selecting a validated control state, or interpolating between validated control states. The method can further include estimating one or more latent or indirectly observable variables, including expected penetration behavior, cure response, bond-line retention, product-property development, feedstock-response behavior, or likely process response, from measured and historical data and using the estimated variable in determining the adjustment.

The method can further include associating an artificial-intelligence-derived output with one or more rule-based guardrails, validated operating limits, explainability outputs, operator alerts, override conditions, or combinations thereof so that adaptive control remains within validated safety, quality, and equipment constraints. In some cases, the method includes assigning a confidence level to a recommended adjustment and automatically implementing the adjustment when the confidence level satisfies a threshold, while deferring implementation, maintaining a hold condition, or requesting operator review when the confidence level does not satisfy the threshold or when the recommended adjustment falls outside a validated operating range. Measured outcomes from previously implemented adjustments can be stored and analyzed to refine correlations, retrain predictive models, and improve later determinations during ongoing production or later production intervals.

### System for Implementing the Methods

The methods of the invention may be implemented using a system configured to receive measured information associated with an inherently variable feedstock, an industrial process, a product, or combinations thereof, and to implement one or more adjustments during ongoing operation of the industrial process.

The system may include, for example, one or more measurement devices, a control module, and one or more implementation subsystems. The one or more measurement devices can be configured to obtain measured information indicative of one or more feedstock properties, one or more process conditions, one or more product properties, or combinations thereof. The control module can be configured to receive the measured information and determine one or more target outputs for carrying out the adaptive method. The one or more implementation subsystems can be configured to implement the determined target outputs during operation of the industrial process.

The one or more measurement devices may be positioned at one or more locations along the industrial process, including upstream of formulation application, at or near a point of contact between the inherently variable feedstock and the formulation, within one or more intermediate process stages, downstream of a principal conversion stage, at a finishing stage, or after manufacture of the product. The measured information can include direct measurements, indirect measurements indicative of a condition of interest, or both.

Exemplary measurement devices include feedstock-monitoring devices configured to characterize the state of the inherently variable feedstock before the feedstock is contacted with the formulation. Such measurement devices can include in-line sensors, near-line sensors, off-line analytical systems, laboratory testing systems, or combinations thereof associated with a conveyor, hopper, bin, chute, metering device, blending stage, or other feedstock-handling equipment. The measured information can include, by way of example, moisture content, temperature, density, porosity, particle size, shape, geometry, species composition, extractives content, pH, buffer capacity, contaminant level, ash content, recycled-content composition, storage condition, upstream processing history, or another property indicative of the state of the inherently variable feedstock.

The measurement devices may further include process-monitoring devices configured to measure conditions associated with operation of the industrial process. Such measurement devices can include in-line sensors, equipment-integrated monitors, equipment historians, supervisory control and data acquisition interfaces, programmable logic controller interfaces, distributed control system interfaces, environmental data feeds, forecast data sources, or combinations thereof. The measured information can include, by way of example, temperature, pressure, flow rate, line speed, residence time, mixing intensity, formulation application rate, drying condition, curing condition, compaction condition, energy consumption, motor load, torque, vibration, humidity, ambient condition, or another measurable condition associated with process behavior.

Further measurement devices may include product-monitoring devices configured to measure an in-process product property, an intermediate product property, a finished product property, or a combination thereof. Such measurement devices can be positioned at one or more downstream locations selected to provide information indicative of how the inherently variable feedstock and the formulation are interacting during manufacture or how the resulting product is performing. The measured information can include, by way of example, cure state, thickness, density, density profile, bond performance, internal bond strength, dimensional stability, thickness swell, water absorption, moisture resistance, surface quality, emissions, color, gloss, strength, modulus, dielectric response, thermal response, acoustic response, or another property indicative of product quality or process outcome. In some aspects, product-related measured information is obtained from in-line sensors, near-line sensors, off-line testing systems, laboratory testing systems, quality databases, operator-input interfaces, or combinations thereof.

The system may further include non-sensor measurement sources and contextual data-input sources that provide measured information or other information relevant to control of the industrial process. Such sources can include laboratory information systems, manual operator entries, maintenance records, quality databases, production schedules, raw-material receipts, supplier data, enterprise resource planning systems, manufacturing execution systems, environmental monitoring systems, forecast data sources, or combinations thereof. Such information can provide context regarding identity, origin, expected variability, prior treatment, or likely future state of the inherently variable feedstock, the formulation, the industrial process, or the product.

The system control module is configured to receive measured information from the measurement architecture, determine a current or predicted manufacturing state, and select, based on the determined state, whether an appropriate response comprises a target formulation, a target process parameter adjustment, a target feedstock adjustment, or a coordinated combination thereof. The determined manufacturing state can represent, for example, a feedstock state, a formulation-response state, a process state, a product-performance state, or a combination thereof. In some aspects, the control module evaluates whether the determined manufacturing state is within a desired operating condition, is trending away from the desired operating condition, or corresponds to a condition associated with an undesirable manufacturing outcome, and determines from that evaluation whether a control action is to be implemented.

The control module may comprise one or more processors, industrial computers, programmable logic controllers, distributed control system controllers, supervisory computers, server systems, cloud-computing resources, or combinations thereof configured to receive measured information and determine one or more target outputs for the adaptive method. The control module may further include one or more memory resources configured to store measured information, model parameters, calibration information, validated operating ranges, validated control states, historical operating information, implementation instructions, or combinations thereof. The control module may be implemented locally, remotely, or in a distributed architecture in which different control or analytical functions are carried out at different locations.

The control module can determine a target output using one or more decision resources, including one or more rules, correlations, empirical models, mechanistic models, machine-learning models, response surfaces, validated control states, validated process recipes, validated formulation states, validated feedstock adjustment states, historical operating regimes, or combinations thereof. In some aspects, the control module determines a candidate adjustment by selecting a validated adjustment from a plurality of validated adjustments or by interpolating between validated adjustments. The control module may evaluate whether the adjustment is within a validated operating range before implementation. Where multiple candidate adjustments are available, the control module can select among them based on predicted effect on product consistency, predicted effect on process stability, implementation latency, equipment availability, material constraints, safety constraints, confidence level, or combinations thereof.

The control module can include one or more software modules configured to use artificial intelligence in processing measured information and supporting determination of a target formulation, a target process parameter adjustment, a target feedstock adjustment, or a coordinated combination thereof during operation of the industrial process. The artificial intelligence can include one or more rules-based models, statistical models, machine learning models, neural networks, optimization routines, model predictive control routines, digital twin models, expert systems, or combinations thereof. The control module can use such artificial intelligence to perform one or more of feedstock classification, anomaly detection, sensor fusion, soft sensing of an unmeasured property, prediction of one or more downstream product properties, recommendation of an adjustment, confidence scoring, or constrained optimization within a validated operating envelope. In some cases, the control module stores one or more validated operating ranges, validated control states, historical operating records, or combinations thereof and uses the artificial intelligence together with such stored information to support determination of whether a recommended adjustment is to be automatically implemented, deferred, or presented for operator review.

The one or more implementation subsystems may include formulation-adjustment equipment, process-control equipment, feedstock-adjustment equipment, or combinations thereof. Formulation-adjustment equipment may include storage vessels, metering devices, dosing pumps, mixers, blend manifolds, recirculation loops, proportioning devices, applicators, or combinations thereof configured to assemble, modify, or deliver a formulation at or near a point of use. Process-control equipment can include heaters, coolers, presses, dryers, mixers, conveyors, pumps, fans, flow-control devices, pressure-control devices, line-speed controls, residence-time controls, applicator controls, or combinations thereof configured to adjust one or more operating parameters of the industrial process. Feedstock-adjustment equipment may include source-selection devices, routing devices, blend conveyors, bins, classifiers, screens, refiners, grinders, dryers, humidifiers, pretreatment applicators, chemical-addition devices, or combinations thereof configured to change the state of the inherently variable feedstock before or during contact with the formulation.

The system may further include a data infrastructure configured to collect, store, organize, and analyze operational information associated with one or more production intervals. Operational and performance data from one or more manufacturing lines or facilities can be aggregated to maintain historical operating records, refine models, update validated operating ranges, identify operating regimes associated with desired outcomes, or improve later determinations. The system may also be configured to account for timing relationships associated with implementation of an adjustment, including transport delay, residence time, mixing delay, equipment latency, line position, product position, batch identity, lot identity, or combinations thereof, so that a determined target output is implemented at an appropriate stage of production.

The system is preferably configured to account for transition timing, equipment latency, and line position so that a determined target output is implemented at the appropriate stage of production. For example, the control module may determine an effective start time for a target formulation, a target process parameter adjustment, or a target feedstock adjustment based on equipment residence time, transport delay, blending delay, process-cycle timing, or product position within the line. The control module may manage transition states by determining a purge composition, a transient blend state, a staged setpoint change, or another transition protocol so that control changes are synchronized with ongoing production. Different target outputs may be directed to different portions of a product, different product layers, different zones of a process, or different production intervals so as to produce a zoned or gradient product architecture.

The control module may be configured to not only determine whether a single control variable should be changed, but to also determine which category of control action is to be implemented in response to the measured information. Thus, the control module may determine whether the more effective corrective action lies in changing the formulation, changing one or more process parameters, changing the feedstock presented to the process, or changing a combination thereof. In some aspects, the control module determines and implements at least two of the target formulation, the target process parameter adjustment, and the target feedstock adjustment in coordination with one another. In some aspects, the control module determines and implements at least three of the target formulation, the target process parameter adjustment, and the target feedstock adjustment in coordination with one another. The control module may use root-cause logic, hierarchical control logic, constrained optimization, model-based prediction, statistical process control, machine learning, or combinations thereof in determining the appropriate control action or coordinated set of control actions.

The control module may be configured to determine target outputs using a library of validated control states, validated formulation states, validated feedstock adjustment states, validated process recipes, historical operating regimes, or combinations thereof. In some aspects, the control module may select a validated control state from a plurality of validated control states and/or may interpolate between validated control states. In some aspects, the selected or interpolated target output is constrained to remain within a validated operating range. The control module may assign a confidence value to a candidate control action and may automatically implement the candidate control action when the confidence value satisfies a threshold, while issuing an alert, recommendation, or operator review request when the confidence value does not satisfy the threshold.

### Engineered Wood Products

In one example and to illustrate the invention, the methods are implemented in an engineered wood product manufacturing process in which wood furnish is contacted with a wood adhesive and processed to form a consolidated engineered wood product. The engineered wood product may comprise, for example, particleboard, medium-density fiberboard, oriented strand board, fiberboard, hardboard, insulation board, a laminated wood product, a composite panel, or another wood-based product formed from wood furnish and a wood adhesive. The wood furnish may comprise particles, strands, fibers, flakes, veneers, fines, recycled wood material, agricultural fiber, lignocellulosic material, or combinations thereof

Wood furnish may vary over time in one or more compositional properties, physical properties, or both, and such variation can influence interaction between the wood furnish and the wood adhesive during manufacture. Compositional properties include, for example, species composition, extractives content, pH, buffer capacity, tannin content, soluble organic content, ash content, or combinations thereof. Physical properties include, for example, moisture content, density, porosity, particle size, particle-size distribution, flake form, fiber form, strand geometry, aspect ratio, fines content, surface area, bulk density, compressibility, and other geometry-related or morphology-related properties of the wood furnish.

Compositional variability can arise from changes in species mix, source location, growth conditions, season, storage history, recycled-content contribution, bark content, heartwood-to-sapwood ratio, upstream processing history, or combinations thereof. Two furnish streams may therefore have similar moisture content, temperature, and particle-size distribution while differing in pH, extractives content, or buffer capacity in a manner that causes the same wood adhesive to behave differently during manufacture. Measured compositional information, measured physical-property information, or both may be used in determining how manufacture is to be adjusted during ongoing production.

The method can distinguish between physical variability and compositional variability, while recognizing that the two may interact. Moisture content, temperature, density, porosity, or geometry of the wood furnish can influence process behavior and can also affect interpretation of one or more compositional measurements. The method may therefore determine a current furnish state using both physical-property measurements and compositional-property measurements and can further determine whether a detected condition is more appropriately addressed through adhesive adjustment, process adjustment, furnish adjustment, or a coordinated combination thereof.

Measured information may include one or more of furnish moisture content, furnish extractives indicator, furnish pH, furnish buffer capacity, adhesive gel time, mat moisture content, press temperature, dielectric response, density profile, internal bond strength, thickness swell, water absorption, emissions, water absorption, water resistance, density, density profile, screw holding capacity, particle geometry, delamination resistance, thickness, thickness variation, defects, modulus of rupture, modulus of elasticity, mat weight, mat uniformity, and particle size distribution, or combinations thereof. The wood furnish may be sampled or evaluated from an incoming material stream, an intermediate furnish stream, or a furnish stream immediately before contact with the wood adhesive. Analytical testing can be performed using one or more techniques selected according to the wood furnish being processed and the variability to be characterized. Where appropriate for a selected analytical technique, the sampled wood furnish can be conditioned before analysis, including by drying, equilibration, or controlled-environment conditioning, so that a measured property more accurately reflects a target comparison state. In other cases, the measured information is obtained from wood furnish in its as-received or as-processed state so that the adaptive process responds to the actual state of the inherently variable feedstock presented during ongoing manufacture. Measurements produced using these tools help define material-specific formulation parameters. These tools and their uses include:
a. Infrared Spectroscopy (IR, FTIR, NIR): These techniques involve measuring the absorption of infrared radiation by functional groups in wood components. FTIR operates in the mid-infrared range (4000-400 cm⁻¹) and is effective for identifying chemical bonds characteristic of lignin (aromatic C═C at 1510-1600 cm⁻¹), cellulose (C—O and C—H stretches near 1000-1100 cm⁻¹), and hemicellulose (carbonyl bands near 1730 cm⁻¹). NIR (near-infrared) spectra capture overtones and combinations of these vibrations and are especially useful for rapid, non-destructive estimation of moisture content and bulk chemical composition.
b. X-ray Densitometry: This technique uses the attenuation of X-ray beams through wood samples to measure density distribution. Higher density areas absorb more radiation. It is useful for evaluating internal wood structure, locating dense knots or growth rings, and assessing variation across strands or veneers used in OSB or plywood.
c. BET (Brunauer-Emmett-Teller) Surface Area Analysis: Bet Analysis Involves

nitrogen gas adsorption onto the surface of finely milled wood samples under vacuum. The technique provides a measure of specific surface area (m²/g), which correlates with how much resin may interact with or coat the wood surface. It is particularly applicable when working with fibrous or powdered wood forms.
d. Surface Profilometry: Profilometry measures surface topography using a stylus or optical scanner to generate a profile of the wood surface. Parameters such as Ra (average roughness) or Rz (peak-to-valley height) are determined. These affect how well the adhesive spreads and anchors to the wood surface. Surface profilometry may be measured and interpreted in accordance with DIN EN ISO21920.
e. Mercury Intrusion Porosimetry: This method involves forcing mercury into the pores of a wood sample under increasing pressure. The volume and pressure data are used to derive pore size distribution and total porosity. Woods with high porosity may absorb more adhesive, requiring viscosity or solids content adjustments. The mercury intrusion porosimetry may be performed in accordance with ASTM D4284.
f. Contact Angle or Dyne Test: Contact angle is an angle formed when a liquid is contacted with a surface. The lower the contact angle the higher the surface energy. Dyne Test is a test where ink with a known surface tension is applied on a surface. The surface energy is determined by observing how the ink spreads.
g. Thermogravimetric Analysis (TGA): TGA measures weight loss as a sample is heated in a controlled atmosphere. The initial weight loss corresponds to moisture, while additional losses at higher temperatures relate to volatile extractives and thermal degradation of hemicellulose and lignin. These values inform both cure behavior and the need for scavengers or modifiers. The TGA may be performed in accordance with ASTM E1131.
h. Gas Chromatography-Mass Spectrometry (GC-MS): GC-MS separates and identifies volatile and semi-volatile organic compounds. For wood, this includes resins, terpenes, oils, and tannins. Extractives can inhibit adhesion and may require surfactants or pre-treatment. GC-MS data supports the adjustment of wetting agents or primer strategies.
i. Contact Angle Measurement: This technique evaluates the wetting behavior of a liquid droplet (typically water) on the wood surface. The angle between the droplet and surface (in degrees) provides a measure of hydrophobicity. Low contact angles indicate good wetting, while high angles suggest extractive-rich or resinous surfaces that may benefit from formulation changes.
j. Ultrasound Velocity Analysis: Ultrasound waves are transmitted through a wood sample, and the speed of propagation is recorded. Higher velocity generally indicates higher stiffness and lower internal void content. This technique is useful for evaluating structural integrity and correlates with bonding potential in composite panels. The ultrasound velocity analysis may be performed in accordance with ASTM C1331-18.

The resulting measurements can be expressed as one or more property values or derived features, including moisture content, density, roughness, porosity, wetting state, compositional ratio, extractives indicator, geometry-related state, or combinations thereof. One or more compositional properties can be measured directly or inferred from indirect measurements indicative of the relevant state. For example, spectral information can be used to estimate species composition or chemical class, pH can be used to indicate a likely furnish-adhesive interaction state, dielectric response can be used to indicate cure progression associated with furnish chemistry, and temperature-profile information can be used to indicate a reaction or cure condition influenced by wood furnish composition. One or more of a calibration model, correlation model, classification model, or other inference logic may be applied to convert one or more such measurements into a control-relevant feature representative of the state of the wood furnish.

### Control-Relevant Compositional Properties

Buffer capacity is a particularly useful example of a compositional property of wood furnish that can influence adhesive behavior. Buffer capacity can be understood as an indication of the extent to which wood chemistry affects the acidity or basicity of the local environment encountered by the adhesive during processing. Where the wood adhesive includes a cure mechanism sensitive to chemical environment, variation in buffer capacity can change the effective cure conditions experienced by the adhesive even if nominal formulation composition and nominal process settings remain unchanged. A change in buffer capacity can shift the relationship between catalyst loading, cure rate, cure uniformity, press behavior, and resulting panel performance. Accordingly, measured buffer capacity, or an indirect measurement indicative of buffer capacity, can be used as a control-relevant feedstock property for determining a target wood adhesive, a target process parameter adjustment, a target wood furnish adjustment, or a coordinated combination thereof.

Furnish pH is also a useful compositional property or indicator of furnish chemistry. Measured pH can provide direct information regarding the chemical state of the wood furnish or indirect information regarding the likely interaction between the wood furnish and the wood adhesive. The pH can be measured on the wood furnish itself, on an extract or slurry derived from the wood furnish, on a furnish-adhesive mixture, or at another location or stage indicative of the chemical environment relevant to adhesive response. The pH may be used alone as a control-relevant feature, or pH may be used in combination with one or more other direct or indirect measurements, such as species information, spectral information, or cure-response information, to infer a broader compositional state of the wood furnish.

The extractives content or an extractives indicator may also be used as a control-relevant property. Extractives can vary across wood species and furnish sources and can influence wettability, cure chemistry, emissions behavior, or other aspects of interaction between the wood furnish and the wood adhesive.

Species composition can likewise be used as a direct or indirect indicator of furnish chemistry, whether measured directly or inferred from spectral information, source information, or another correlated input. Measured or inferred compositional variability can therefore be used alone or in combination with moisture content, geometry-related properties, cure-response information, or other measured information in determining how the manufacturing method is to be adjusted.

### Adhesive-Related Adjustments

Adaptive wood adhesive adjustments may be achieved by determining and implementing a target wood adhesive responsive to a current or predicted state of the wood furnish, the manufacturing process, the engineered wood product, or a combination thereof. The target wood adhesive may, in some instances, be determined before a corresponding portion of the wood furnish reaches an adhesive application stage so that the determined adhesive state is applied on a timescale effective to influence subsequently produced product.

Adhesive-related adjustments may include, for example, selection of a resin type, adjustment of a ratio among adhesive components, adjustment of resin solids content, viscosity condition, hardener concentration, scavenger concentration, surfactant concentration, rheology-modifier concentration, or additive selection. Where measured information indicates elevated extractives content, altered wetting behavior, or another furnish state associated with reduced adhesive compatibility, the method can increase a scavenger level, introduce or increase a surfactant, adjust viscosity, change solids content, or otherwise determine a target wood adhesive better matched to the measured furnish state. The target wood adhesive may be prepared by combining or proportioning two or more stock adhesive compositions, resin streams, additive streams, or combinations thereof to achieve a desired adhesive state at or near a point of use.

The wood adhesive may comprise a phenolic resin system, an amino resin system, or a combination thereof. For example, the wood adhesive can comprise a phenol-formaldehyde resin, a phenol-resorcinol-formaldehyde resin, a resorcinol-formaldehyde resin, a urea-formaldehyde resin, a melamine-formaldehyde resin, a melamine-urea-formaldehyde resin, an acetone-formaldehyde resin, or a combination thereof. A phenolic resin system may include a phenol-formaldehyde resin, a phenol-formaldehyde resole resin, a phenol-resorcinol-formaldehyde resin, a resorcinol-formaldehyde resin, an emulsified phenol-formaldehyde resin, or a combination thereof.

In adhesive systems including phenolic resin systems, amino resin systems, or combinations thereof, molecular weight can correlate with degree of condensation and reactive-group distribution. Higher-molecular-weight fractions may comprise more extensively condensed oligomeric species, while lower-molecular-weight fractions can comprise shorter oligomeric species having greater mobility and different penetration behavior prior to gelation. Blending of such fractions can therefore provide a mechanism for adjusting adhesive architecture, including effective reactive-group distribution, transport behavior, cure behavior, and resulting network structure. A target wood adhesive can accordingly be achieved through adaptive blending of adhesive fractions having different molecular-weight characteristics in response to measured feedstock properties, measured process conditions, measured product properties, or combinations thereof.

Optional additives or additional components used in the wood adhesive can include acidic catalysts, alkaline catalysts, polar solvents, non-polar solvents, formaldehyde scavengers, processing aids, plasticizers, rheology modifiers, fillers, flame retardants, lubricants, softening agents, pigments, biocides, latent acid donors including acid anhydrides or alkyl esters, surfactants, latexes, hydrophobic agents including waxes, or combinations thereof. Although thermosetting adhesive systems are described in many examples, the target adhesive principles disclosed herein may also be applied to other curable, thermoplastic, or activatable adhesive systems, including moisture-activated systems, isocyanate-based systems, vapor-deposited systems, radiation-curable systems, hybrid systems, or combinations thereof, provided that one or more architectural attributes influencing transport behavior, cure behavior, or network formation can be adjusted at or near a point of use.

In one example, measured or inferred furnish variability may be used to determine the target wood adhesive. Where measured information indicates a shift in species composition, extractives content, pH, buffer capacity, wetting behavior, or a combination thereof, the method can determine a corresponding adjustment in catalyst loading, additive dosage, resin blend state, solids condition, viscosity condition, or another adhesive-related variable so that the target wood adhesive remains better matched to the detected furnish state. The target wood adhesive can be prepared by combining or proportioning two or more stock adhesive compositions, resin streams, additive streams, or combinations thereof to achieve a desired adhesive state at or near a point of use. The method may further include monitoring one or more properties associated with preparation and application of the wood adhesive, including pH, temperature, specific gravity, viscosity, component ratio, or combinations thereof, so that the implemented target wood adhesive conforms to the determined adhesive state.

The target wood adhesive may be achieved from a plurality of standardized formulation components supplied as modular building blocks rather than as a single fixed finished adhesive. Each standardized formulation component may be characterized by one or more defined attributes, including resin identity, average molecular weight or molecular weight distribution, solids content, viscosity profile, pH, reactive-group density, incorporated additive content, or combinations thereof. The standardized formulation components may be stored separately at a manufacturing facility and are selectively combined at or near a point of use in response to measured information obtained during operation of the wood product manufacturing system.

The plurality of standardized formulation components may comprise at least a first standardized adhesive composition comprising a higher-average-molecular-weight resin fraction and a second standardized adhesive composition comprising a lower-average-molecular-weight resin fraction. The higher-average-molecular-weight resin fraction can contribute bond-line retention, cohesive strength, cured-network integrity, and durability after cure, while the lower-average-molecular-weight resin fraction can contribute wetting, mobility, and penetration before gelation. In some aspects, the target wood adhesive is achieved by blending the first standardized adhesive composition and the second standardized adhesive composition in a blend ratio determined from measured information obtained during ongoing operation of the wood product manufacturing system. The blend ratio may be determined in coordination with catalyst level, solids level, scavenger level, wax level, rheology-modifier level, or another adhesive variable so that multiple adhesive attributes are adjusted together in achieving the target wood adhesive.

### Process Parameter Adjustments

The method further include determining and implementing at least one target process parameter adjustment responsive to a current or predicted process condition, cure condition, product-performance condition, or combination thereof. The target process parameter adjustment may be implemented on a timescale effective to influence subsequently produced product, including by accounting for transport delay, residence time, implementation latency, and a positional relationship between a measured condition and the portion of material to be affected by the adjustment.

The target process parameter adjustment includes an adjustment to one or more operating parameters associated with furnish handling, adhesive application, forming, consolidation, curing, finishing, or combinations thereof. Examples include adjustment to press time, press temperature, press pressure, press closing profile, press opening profile, press schedule, dryer condition, furnish moisture target, adhesive application rate, blender residence time, mixing intensity, mat basis weight, mat moisture content at press entry, line speed, or combinations thereof.

Process parameter adjustment may be a preferred response where the wood adhesive remains within a suitable adhesive state while a kinetic limitation, heat-transfer limitation, moisture-related limitation, or densification-related limitation is likely to affect cure uniformity or product performance. The target process parameter adjustment may be determined responsive to measured or inferred cure progression, including cure state inferred from dielectric response, press temperature profile, energy input profile, mat temperature rise, or combinations thereof, and can further be responsive to downstream product-property measurements including internal bond strength, density profile, thickness swell, water absorption, emissions, or combinations thereof.

The target process parameter adjustment may be determined independently or in coordination with the target wood adhesive, the target wood furnish adjustment, or both. For example, the process can determine both a target catalyst loading and a coordinated press time adjustment where measured information indicates that a change in furnish chemistry is likely to alter adhesive cure behavior. The target process parameter adjustment can be constrained to remain within validated operating ranges associated with panel thickness, panel density, line throughput, safety limits, equipment capability, or combinations thereof. Adaptive process parameter control can thereby improve cure uniformity, densification behavior, bond performance, panel consistency, or combinations thereof while permitting continued manufacture despite variation in the wood furnish.

### Wood Furnish Adjustment

Adaptive wood furnish adjustment can be achieved by determining and implementing a target wood furnish adjustment that changes the state of the wood furnish before or during contact with the wood adhesive. The target wood furnish adjustment maintains the wood furnish within a target furnish state or target furnish range associated with more consistent interaction with the wood adhesive and more consistent manufacture of the engineered wood product. The adjustment may be implemented upstream of an adhesive application stage so that the changed furnish state is presented to the adhesive application stage and a downstream consolidation stage in a time frame effective to influence subsequently produced product.

The target wood furnish adjustment may comprise source selection or source blending among a plurality of furnish sources. Different furnish sources can be associated with different furnish states, including different species mixes, different extractives levels, different pH values, different buffer capacity values, different moisture states, different fines levels, different geometry distributions, or combinations thereof. A target source-blend ratio may be determined based on measured or inferred furnish chemistry, measured or inferred furnish geometry, or both so as to reduce the magnitude of a detected furnish-state shift, reduce the rate of change of furnish state over time, or keep furnish state within a target range during ongoing production.

The target wood furnish adjustment may also include conditioning the wood furnish, including moisture conditioning, temperature conditioning, screening, classification, routing, storage selection, geometry control, fines management, or combinations thereof. The target wood furnish adjustment may further comprise chemical treatment of the wood furnish upstream of adhesive application, including application of a pH-modifying agent, a buffering agent, a neutralizing agent, a scavenger, or another furnish treatment configured to alter the chemical environment encountered by the wood adhesive.

The target wood furnish adjustment may be determined from measured or inferred furnish chemistry, measured physical furnish properties, measured process conditions, measured product properties, or combinations thereof. For example, the method can determine a target source-blend ratio, a target moisture condition, a target fines-management action, a target geometry-related adjustment, or a target furnish-treatment dosage responsive to measured or inferred pH, buffer capacity, extractives content, species composition, flake form, adhesive gel time, thickness swell, water absorption, or another condition indicative of mismatch between the wood furnish and the wood adhesive. The target wood furnish adjustment may be used as a primary response while the wood adhesive and/or process parameters are held substantially constant, or it can be coordinated with the target wood adhesive, the target process parameter adjustment, or both.

### Coordinated Adjustment

Adaptive coordinated adjustment includes the selection among adaptive wood furnish adjustment, adaptive wood adhesive adjustment, and adaptive process parameter adjustment, and by allocating corrective action among two or more such pathways where appropriate. The method can determine whether a detected condition is more effectively addressed through feedstock-side correction, adhesive adjustment, process adjustment, or a coordinated combination thereof. For example, a detected shift in furnish chemistry can be addressed primarily by changing a furnish source-blend ratio while adhesive and process conditions remain unchanged. In other cases, the detected shift can be addressed primarily by changing the target wood adhesive without requiring a furnish adjustment. In still other cases, the detected condition is addressed by a coordinated combination of a target wood furnish adjustment, a target wood adhesive, and a target process parameter adjustment, with implementation timing selected so that the combined response affects a corresponding portion of subsequently produced engineered wood product.

More broadly, adaptive coordinated control may be used to balance competing objectives among feedstock stability, adhesive performance, process stability, throughput, and product performance. The method therefore determines not only which corrective pathway is technically available, but which pathway or combination of pathways is more suitable for a particular detected condition based on expected effectiveness, implementation timing, operating constraints, and validated operating ranges. In this manner, the method permits coordinated correction of variation in the wood furnish while maintaining more consistent operation of the manufacturing process and more consistent properties of the resulting engineered wood product.

One or more measured product properties from panels or other engineered wood products produced using a determined adhesive state, process condition, furnish state, or coordinated combination thereof may be used to evaluate the effect of the implemented adjustment and refine a later determination. Such measured product properties include, for example, internal bond strength, modulus of rupture, modulus of elasticity, thickness swell, water absorption, cyclic delamination performance, emissions, or combinations thereof. The measured product properties may be correlated with measured state of the wood furnish, determined adhesive state, and one or more process conditions so that subsequent determinations are better matched to recurring states of the wood furnish. Reliance on fixed recipes is reduced and consistency of product performance is improved despite variation in the wood furnish.

The wood product manufacturing process may be configured to produce a multilayer or zoned engineered wood product in which different portions of the product are associated with different furnish states, different adhesive conditions, or different process conditions. For example, face layers and interior layers of a panel can be formed from different furnish fractions or can be exposed to different target wood adhesives, different target process parameter adjustments, different target wood furnish adjustments, or combinations thereof. Measured information may be associated with a particular furnish stream, product layer, product zone, or production interval and determines corresponding target outputs for that layer, zone, or interval. In this manner, the method may be used not only to maintain consistency of panel properties across a production run, but also to intentionally produce a zoned or gradient product architecture within the engineered wood product.

### Method for Manufacturing Oriented Strand Board

Another illustrative example relates to an method for manufacturing oriented strand board using a wood furnish comprising flakes and a polymeric methylene diphenyl diisocyanate (pMDI) adhesive. In such a method, the inherently variable feedstock can vary not only in compositional properties but also in physical properties including moisture content, flake form, fines fraction, strand geometry, aspect ratio, particle-size distribution, surface area, or combinations thereof. Such variation can influence adhesive demand, adhesive distribution, wetting behavior, cure behavior, consolidation behavior, and resulting board performance. Measured information indicative of such feedstock state can therefore be used to determine a target adhesive loading, a target process parameter adjustment, a target wood furnish adjustment, or a coordinated combination thereof.

Measured information used in such oriented strand board processes may include direct or indirect measurements of furnish moisture state, flake-form state, and resulting board-response state. For example, moisture state can be measured or inferred using infrared measurements, including Fourier-transform infrared measurements, near-infrared measurements, or combinations thereof. Flake-form state can be measured or inferred using imaging systems, optical analysis systems, particle-characterization systems, particle-size analyzers, or combinations thereof. The measured flake-form state can represent, for example, the relative proportion of fines, the prevalence of longer flakes, a geometry distribution, or another morphology-related condition of the wood furnish. The measured information may be used to determine whether a current adhesive loading remains suitable, whether adhesive loading is to be increased or maintained, whether a process condition is to be changed, whether a feedstock-preparation adjustment is to be implemented, or whether a coordinated response is more appropriate.

In some operating conditions, an increase in furnish moisture content may cause a previously suitable adhesive loading to become less effective. The measured moisture information may be used as a control input for determining a target adhesive loading. Where the measured moisture state shifts from a first moisture condition to a second moisture condition associated with reduced board performance at a fixed adhesive loading, the process determines a higher target adhesive loading effective to restore one or more board properties toward a target range. The resulting board-response state is evaluated using a plurality of measured product properties rather than a single property alone. Such measured product properties can include water absorption, thickness swell, internal bond strength, a D4 value, percentage of measurable internal-bond specimens able to be obtained per board, or combinations thereof. In this manner, it can be determined whether a changed adhesive loading has improved board performance across multiple relevant output metrics.

In some operating conditions, the measured feedstock state can indicate that a current adhesive loading remains within a validated retained-performance operating window. For example, where measured furnish moisture, measured flake form, and measured product properties indicate that the current adhesive loading continues to provide acceptable board performance across a defined operating range, the current adhesive loading may be maintained rather than escalating adhesive use unnecessarily. It is possible to therefore determine not only when adhesive loading should be increased, but also when an existing loading should be held because the measured state remains within a validated operating window associated with retained performance.

The measured flake-form state can also be used as a control-relevant feedstock property. For example, a furnish state associated with longer flakes, lower fines content, or a more favorable geometry distribution can support acceptable board performance at a lower or moderate adhesive loading, while a furnish state associated with increased fines content, less favorable geometry, or greater effective surface area can increase adhesive demand. Accordingly, the measured flake-form information may be used to determine whether a lower adhesive loading remains viable, whether adhesive loading should be increased, or whether a target wood furnish adjustment should be implemented. Such a target wood furnish adjustment can include screening, sieving, classification, source selection, source blending, routing, or another feedstock-preparation adjustment directed to bringing the wood furnish toward a target geometry state associated with reduced adhesive demand or improved board consistency.

It is further possible to account for process boundaries that are not fully corrected by adhesive adjustment alone. For example, where a measured process condition indicates a shortened press schedule or another process limitation associated with inadequate bond development, it may be determined that increased adhesive loading by itself is insufficient or less preferred. In such cases, a target process parameter adjustment may be identified comprising maintenance or restoration of a press time, press schedule, or another process condition associated with acceptable consolidation and bond development. A coordinated response may be used in which adhesive loading and press conditions are adjusted together, while in other aspects the control module determines that restoration of a process condition is preferred to further adhesive escalation.

### Industrial Processes Using the Methods and Systems of the Invention

Although the foregoing description focuses in part on wood product manufacturing processes, the method is not limited to wood furnish, wood adhesives, or engineered wood products. Rather, the wood-product-specific aspects described above illustrate one implementation of a broader adaptive industrial process in which an inherently variable feedstock is contacted with a formulation and measured information is used during ongoing operation to determine and implement a target formulation, a target process parameter adjustment, a target feedstock adjustment, or a coordinated combination thereof. The same method can be applied in other industrial processes in which variability in feedstock state influences formulation behavior, process behavior, product formation, product performance, or combinations thereof, and in which improved manufacturing consistency can be achieved by determining which category of control response is appropriate for a detected condition.

For instance, a feedstock may include, for example, a fibrous feedstock, a mineral feedstock, a particulate feedstock, a paper or web feedstock, a powder feedstock, a porous substrate, a recycled feedstock, a chemically heterogeneous feedstock, or another feedstock whose relevant properties vary over time, between lots, between sources, or between portions of a production stream. The method can thereby be used in a wide range of industrial processes in which a fixed formulation, fixed process setting, or fixed feedstock-conditioning approach would otherwise produce inconsistent manufacturing outcomes.

The method may be implemented in a glass mat manufacturing process in which a binder, coating, or impregnation formulation is contacted with a glass fiber feedstock to produce a glass mat product. The glass fiber feedstock can vary in fiber diameter, fiber length distribution, sizing chemistry, surface-treatment state, moisture condition, or source-lot composition. One or more measurement devices can measure, directly or indirectly, one or more feedstock properties, one or more process conditions, one or more product properties, or combinations thereof, including fiber throughput, basis weight, binder pickup, oven temperature profile, line speed, mat tensile strength, basis weight uniformity, dimensional consistency, or combinations thereof. Based on the measured information, a target binder formulation, a target oven or line-speed adjustment, a target glass-fiber blend adjustment, a target fiber pre-treatment adjustment, or a coordinated combination thereof is adjusted so as to improve mat integrity, binder distribution, cure behavior, and product uniformity during ongoing production.

Alternatively, the method may be implemented in a resin-impregnated paper, melamine paper, low-pressure laminate, high-pressure laminate, or related web-processing operation in which a paper or fibrous sheet feedstock is contacted with a resin formulation and processed to produce an impregnated or laminated product. The sheet feedstock can vary in basis weight, porosity, absorbency, moisture content, fiber composition, surface energy, caliper, or source-lot characteristics. One or more measurement devices can measure resin pickup, web tension, line speed, oven temperature, moisture content, degree of cure, dimensional stability, surface gloss, thickness, or combinations thereof. A target resin formulation, such as a target solids content, catalyst level, viscosity condition, or resin-advancement state, a target process parameter adjustment such as an oven-temperature or line-speed adjustment, a target feedstock adjustment such as paper-lot selection, paper pre-conditioning, humidity equilibration, or substrate assignment, or a coordinated combination thereof is adjusted so as to maintain target impregnation uniformity, cure behavior, surface quality, and dimensional stability.

The method may further be implemented in a battery-material manufacturing processes in which an electrode slurry formulation is contacted with an active-material feedstock and coated onto a current collector to produce an electrode structure. The active-material feedstock can vary in particle size distribution, surface area, moisture content, surface chemistry, impurity profile, tap density, or lot-to-lot composition. One or more measurement devices can measure slurry viscosity, solids content, coat weight, line speed, drying-zone conditions, film thickness, adhesion, coating uniformity, calendar response, electrochemical performance indicators, or combinations thereof. Based on the measured information, a target slurry formulation, such as a target binder concentration, solvent ratio, dispersant level, conductive-additive ratio, or rheology-modifier level, a target coating or drying adjustment, a target feedstock adjustment such as active-material blending, pre-drying, deagglomeration, classification, or surface treatment, or a coordinated combination thereof is determined and implemented. In this manner, the process improves consistency of electrode microstructure, adhesion, coating uniformity, and resulting electrochemical performance despite variability in the inherently variable feedstock.

In other instances, the method is a cementitious process in which a chemical admixture formulation is contacted with a mineral feedstock comprising cementitious binder, aggregate, supplementary cementitious material, or combinations thereof to produce concrete, mortar, grout, or another cementitious product. The mineral feedstock can be inherently variable with respect to clay content, clay mineralogy, particle size distribution, fines content, moisture condition, aggregate source, cement composition, supplementary cementitious material content, or combinations thereof. One or more measurement devices can measure aggregate moisture, conductivity, turbidity, slump, slump retention, yield stress, air content, mixing energy, compressive strength, dimensional stability, set behavior, or combinations thereof. A target admixture formulation, such as a target superplasticizer architecture, auxiliary-admixture dosage, water-reducer level, retarder level, accelerator level, or air-entraining dosage, a target process parameter adjustment such as mixing-time or water-addition adjustment, a target feedstock adjustment such as aggregate-source blending, aggregate washing, moisture conditioning, clay-reduction treatment, or material-routing adjustment, or a coordinated combination thereof is determined and implemented. Thus, the method can improve workability, slump retention, hardened strength development, and consistency of the resulting cementitious product despite variability in the inherently variable feedstock.

The method may further be implemented in polyurethane or isocyanate-based process in which a feedstock or substrate is contacted with a multi-component reactive formulation to produce a cured foam, elastomer, composite, coating, insulation article, or molded product. The feedstock can comprise a porous substrate, fibrous substrate, particulate substrate, molded substrate, recycled substrate, or another inherently variable feedstock whose moisture state, temperature, density, porosity, surface-treatment state, or chemical condition influences reaction behavior and cured-product properties. One or more measurement devices may measure component viscosity, ambient temperature, humidity, substrate temperature, substrate moisture, rise profile, cell structure, cure profile, dimensional stability, bond quality, mechanical properties, or combinations thereof. Based on the measured information, a target reactive formulation, such as a target isocyanate index, polyol blend composition, catalyst level, surfactant level, blowing-agent level, or chain-extender level, a target process parameter adjustment such as dispensing temperature, mix ratio, or cure-condition adjustment, a target feedstock adjustment such as substrate pre-drying, pre-heating, source selection, surface treatment, or substrate blend change, or a coordinated combination thereof is determined and implemented to maintain target reaction profile, substrate wetting behavior, and cured network structure.

The method may further be implemented in phenolic resin product manufacture, including friction materials, molded composite parts, abrasive products, refractory products, and related articles in which a resin formulation is contacted with a particulate, fibrous, mineral, or blended feedstock to produce a consolidated product. The feedstock may vary in filler composition, fiber content, particulate size distribution, moisture condition, mineralogy, recycled-content level, or surface state. One or more measurement devices can measure mixer torque, power consumption, temperature, viscosity, moisture, particle characterization, green strength, density, hardness, friction behavior, wear resistance, thermal stability, dimensional stability, or combinations thereof. A target resin formulation, such as a target resin solids content, curing-agent dosage, lubricant concentration, friction-modifier level, filler ratio, or diluent level, a target process parameter adjustment such as mixing-time, molding-temperature, or cure-cycle adjustment, a target feedstock adjustment such as raw-material blending, moisture conditioning, particle classification, pre-treatment, or filler substitution, or a coordinated combination thereof is determined and implemented so as to maintain product density, cure behavior, and finished-part performance.

Further examples of the method include implementation in an insulation-material manufacturing process, in which a fibrous or particulate feedstock is contacted with a binder formulation to produce an insulation product. The feedstock may comprise mineral wool, glass wool, cellulosic material, lignocellulosic material, recycled fiber, or another insulating substrate that varies in fiber size distribution, moisture content, bulk density, temperature, source composition, or surface state. One or more measurement devices can measure fiber throughput, basis weight, substrate temperature, moisture content, binder flow rate, oven profile, density, recovery, rigidity, emissions, dust generation, mechanical integrity, or combinations thereof. Based on the measured information, a target binder formulation, such as a target resin chemistry, solids content, catalyst level, crosslinker level, pH, or additive dosage, a target process parameter adjustment such as oven-condition or line-speed adjustment, a target feedstock adjustment such as substrate blending, pre-conditioning, moisture adjustment, or classification, or a coordinated combination thereof is determined and implemented to improve wet-out, cure behavior, density consistency, recovery, rigidity, and emissions performance.

The method may further be implemented in a laminate manufacturing process involving paper-based, fabric-based, polymer-backed, or multi-layer substrate feedstocks contacted with a resin or adhesive formulation to produce a laminated product. The substrate feedstock can vary in basis weight, porosity, caliper, moisture content, surface energy, fiber composition, or lot history. One or more measurement devices can measure resin pickup, web tension, thickness, caliper, temperature profile, bond quality, surface finish, tack, volatile content, dimensional stability, or combinations thereof. A target formulation, such as a target resin composition, catalyst dosage, solids level, viscosity state, or cure profile, a target process parameter adjustment such as lamination temperature, pressure, line speed, or dwell-time adjustment, a target feedstock adjustment such as substrate-lot selection, moisture conditioning, pre-heating, web assignment, or substrate blending, or a coordinated combination thereof is determined and implemented to maintain impregnation uniformity, bond quality, surface finish, and dimensional stability.

The method may further be implemented in chemical treatment or additive-delivery processes in which a treatment formulation is contacted with a flowing feedstock stream to modify one or more downstream properties of the treated material. The feedstock can comprise a liquid stream, particulate stream, slurry stream, recycled stream, waste-derived stream, or another inherently variable process stream having variable composition, pH, conductivity, solids level, contamination level, or reactive-species content. One or more measurement devices can measure flow rate, conductivity, optical response, composition, pH, temperature, downstream treatment effectiveness, or combinations thereof. A target treatment formulation, a target dosing strategy, a target process parameter adjustment, a target upstream stream-blending or conditioning adjustment, or a coordinated combination thereof is determined and implemented so that the treatment remains matched to the changing state of the inherently variable feedstock during operation.

The method may be further implemented in industrial fluid, lubricant, or process-fluid systems in which a fluid formulation is contacted with equipment surfaces, substrates, or process materials during operation and the fluid condition and the contacted feedstock environment vary over time. The inherently variable feedstock can include contamination entering the circulating fluid, process-generated fines, reactive debris, or variable substrate material presented to the fluid system. One or more measurement devices can measure viscosity, dielectric response, contamination level, load, temperature, power consumption, wear indicators, or combinations thereof. Based on the measured information, a target fluid formulation, such as a target additive-package concentration, base-fluid composition, anti-wear dosage, or friction-modifier level, a target operating-condition adjustment, a target feedstock-side adjustment such as filtration, contaminant diversion, source-material routing, or upstream material selection, or a coordinated combination thereof is determined and implemented to maintain target lubrication or process-fluid performance.

The method may further be implemented in processes using recycled, reclaimed, or mixed-source feedstocks in which variability of the feedstock is especially pronounced. Such feedstocks can vary in composition, contamination level, moisture, particle geometry, prior-treatment history, reactivity, or combinations thereof. One or more measurement devices can measure direct or indirect indicators of such variability and a target formulation, a target process parameter adjustment, a target feedstock adjustment, or a coordinated combination thereof is determined and implemented responsive to the measured state. In such aspects, the target feedstock adjustment can comprise source sorting, source blending, classification, contaminant removal, moisture conditioning, or pretreatment of the recycled or reclaimed feedstock before contact with the formulation. The process therefore particularly useful in industrial settings where the feedstock cannot be reliably characterized by a single fixed set of properties across a production run.

The foregoing industrial process examples illustrate that the method is not limited to any particular formulation, feedstock type, or finished product. Rather, the method is applicable wherever an inherently variable feedstock is contacted with a formulation and measured information can be used to determine, during ongoing operation, whether the more effective corrective response lies in changing the formulation, changing one or more process parameters, changing the feedstock presented to the process, or changing a coordinated combination thereof so that subsequently produced product remains more consistent despite variation in the inherently variable feedstock.

### EXAMPLES

### Example 1. Adaptive Formulation Response to Buffer Capacity

Example 1(a)—Buffer Capacity

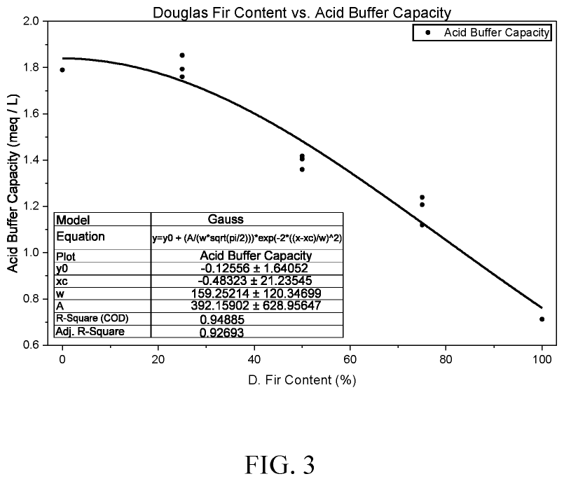

Homogeneous particleboard panels were manufactured using Douglas-fir furnish with a measured buffer capacity of 0.71 (See FIG. 3, demonstrating the buffer capacity as a function of Douglas-fir content). The furnish was first treated with an emulsion wax at a loading of 91.4 g per 8440.5 g of dry furnish and subsequently blended with a urea-formaldehyde resin at 7 wt. % solids (870.6 g per 8440.5 g of furnish). Ammonium sulfate catalyst was incorporated at 0 wt. % (Sample 1), 1.5 wt. % (33.9 g) (Sample 2), and 3.0 wt. % (67.8 g) (Sample 3), based on resin solids. Mats were formed and pressed to target a panel thickness of 0.625″ with a density of 42 lb/ft³ using a short and long press cycle respectively. Short cycle press time had a time to close position of 45 sec; hot press time was 65 sec; degas time was 15 sec, for a total press cycle time of 125 s. The long press cycle had an identical time to close position and degas time with exception to the hot press time of 105 s, for a total press cycle time of 165 s. Internal bond strength (IB) was measured according to ASTM D1037, and variability was expressed as the coefficient of variation (CV).

Buffer capacity was determined through the following method. 30 g of oven dry wood furnish (white oak, Douglas-fir, or a blend of both) and 400.0 mL distilled water was added to a 600 mL beaker. The furnish was soaked in the water for 30 minutes and stirred for 30 seconds at 0, 10, 20, and 30 minutes. The mixture was then decanted through a filter, and 150 mL of the decanted liquid was added to a 400 mL beaker. The liquid was titrated with 0.01 N HCl to a pH of 3.50, recording pH every time 5 mL of HCl was added. The pH was recorded every 1 mL of HCl added once the pH reached 4.0. This method was run in duplicate for each furnish sample.

At 0 wt. % catalyst, the Douglas-fir panels of Sample 1 exhibited internal bond values of 47.9-62.0 psi and CV values of approximately 0.06-0.10, indicating acceptable bond strength and uniform curing across the panels. At 1.5 wt. % catalyst, Sample 2 demonstrated IB values of 44.9-47.9 psi with CV values of approximately 0.07-0.12—performance similar to or slightly below the no-catalyst condition. At 3.0 wt. % catalyst, the IB values of Sample 3 declined to 33.4-34.6 psi, and CV increased to approximately 0.24, indicating both reduced mean bond strength and substantially greater variability in curing uniformity.

For Douglas-fir furnish at buffer capacity 0.71, the inherent acidity of the wood provides sufficient cure activation for the UF resin at low or zero catalyst loading. The low CV values at these conditions demonstrate that curing is spatially uniform—the bondline chemistry is consistent across the panel. Increasing catalyst loading beyond what the furnish chemistry requires does not improve performance; it degrades performance, reducing bond strength and increasing variability as the adhesive system is pushed outside its optimal cure window by excess acidity.

These results establish that for this furnish composition, the appropriate formulation response is low or zero catalyst loading. This represents the target outcome toward which an adaptive system would adjust when it detects low-buffer-capacity furnish—defined here as the formulation that produces both acceptable mean IB and low CV.

### Example 1(b). Comparative-Formulation Failure Under High-buffer-capacity Furnish

Homogeneous particleboard panels were manufactured using white oak furnish with a measured buffer capacity of 1.78—more than twice the buffer capacity of the Douglas-fir furnish characterized in Example 1(a). All other manufacturing parameters were identical to Example 1: the same UF resin at 7 wt. % solids, the same wax loading, the same target density, and the same short and long press cycle times. Catalyst loadings of 0 wt. % (Sample 4), 1.5 wt. % (Sample 5), and 3.0 wt. % (Sample 6) were evaluated. Internal Bond testing was testing in accordance with ASTM D1037

At 0 wt. % catalyst, white oak panels of Sample 4 exhibited internal bond values of 33.3-48.1 psi with CV values reaching approximately 0.49—substantially lower mean performance and dramatically higher variability than Douglas-fir panels at the same condition (Sample 1). At 1.5 wt. % catalyst, Sample 5 demonstrated IB values of 46.9-51.0 psi, but variability remained elevated. At 3.0 wt. % catalyst, Sample 6 demonstrated IB values of 35.7-43.7 psi, accompanied by CV values of approximately 0.25-0.35, indicating that higher catalyst loading still did not resolve the variability problem for this furnish.

These results demonstrate a fundamental failure of fixed-formulation manufacturing when confronted with high-buffer-capacity furnish. No catalyst loading tested—zero, moderate, or high—produced panels with both acceptable mean IB and acceptable variability for white oak furnish. A CV of 0.49 indicates a level of within-panel curing inconsistency that renders the product unreliable for commercial applications, when the average mean bond strength is less than the ANSI A208.1 M-0 standard of 45 psi. The mechanism driving this failure is the mismatch between the formulation's cure requirements and the furnish's chemical environment. White oak's high buffer capacity (1.78) means the wood chemistry partially neutralizes the acidity available to drive UF cure, creating spatially variable cure conditions within the mat. Some regions of the panel cure adequately, while others experience delayed or incomplete curing, resulting in the high CV values observed. Increasing catalyst loading partially offsets the buffering effect on average but cannot eliminate spatial heterogeneity in the curing environment within a single panel.

Critically, this failure is not detectable from the incoming physical properties of the furnish—moisture content and temperature of white oak furnish may be indistinguishable from Douglas-fir furnish. The property that predicts failure is buffer capacity, a compositional property of wood chemistry rather than a physical condition. A manufacturing process that monitors only the physical properties of the furnish—as conventional process control systems do—will not detect the shift from low-buffer to high-buffer furnish and therefore will be unable to respond to it before defective product is produced.

This example, read together with Example 1(a), represents what an adaptive system must accomplish. The two furnish conditions—buffer capacity 0.71 and 1.78—represent the range of compositional variability encountered when a production run processes a shifting species mix. A system that cannot measure this compositional property and adjust the formulation accordingly will produce unacceptable variability whenever the furnish composition shifts toward high-buffer-capacity species. The appropriate adaptive response—adjusting catalyst loading upward as buffer capacity increases, within the range that avoids the over-acidification failure mode demonstrated at 3.0 wt. % in Example 1(a)—cannot be determined from physical measurements alone. It requires measurement of a compositional property of the furnish, either directly (buffer capacity) or through a surrogate accessible during production.

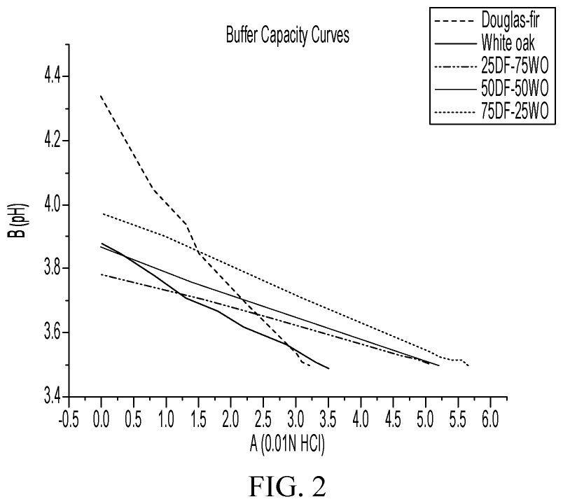

As demonstrated by FIG. 2, buffer capacity varies continuously with species mix. A production run that processes a shifting blend of Douglas-fir and white oak will encounter buffer capacity values spanning the range between these two species throughout the run. A fixed catalyst loading optimized for Douglas-fir will encounter a furnish whose buffering capacity progressively neutralizes the available acidity as the proportion of white oak increases—producing exactly the failure mode demonstrated in Example 1(b). Conversely, a catalyst loading optimized for white oak will over-acidify Douglas-fir-dominated furnish, producing the degraded performance observed at 3.0 wt. % catalyst in this example. Neither fixed formulation performs acceptably across the full range of compositional variability that occurs during continuous operation.

An adaptive manufacturing system that measures buffer capacity—or a surrogate property that correlates with it, such as in-line pH or near-infrared spectral signature of the furnish—on the timescale of the production run can determine the appropriate catalyst loading in real time and adjust the formulation before the variable furnish reaches the press.

### Example 2. Effect of Catalyst Loading and Press Time on Cure Behavior in Low-Buffer-Capacity Furnish

Homogeneous particleboard panels were manufactured using Douglas-fir furnish. Two press cycle times as described in Example 1 were evaluated. Adhesive catalyst loading varied across multiple levels, including 0 wt. % and 3.0 wt. %.

Internal bond strength (IB) and coefficient of variation (CV) were measured for each condition to assess both mean performance and variability. Statistical analysis indicated that catalyst loading, press time, and their interaction significantly affected IB performance (P-value<0.00000, P-value<0.00008, and P-value<0.02391, respectively). IB was measured as according to ASTM D1037.

At 0 wt. % catalyst, increasing hot press time from 125 s to 165 s resulted in an increase in IB and a reduction in variability, as indicated by lower CV values. This behavior is consistent with slower cure kinetics in low-buffer-capacity furnish, where extended press time allows more complete and uniform network formation.

In contrast, at 3.0 wt. % catalyst loading, IB remained low, and CV remained elevated at both press times. Increasing press time from 125 s to 165 s did not improve either mean IB or variability. These results indicate that excessive catalyst loading produces non-uniform curing behavior that is not corrected by extended pressing.

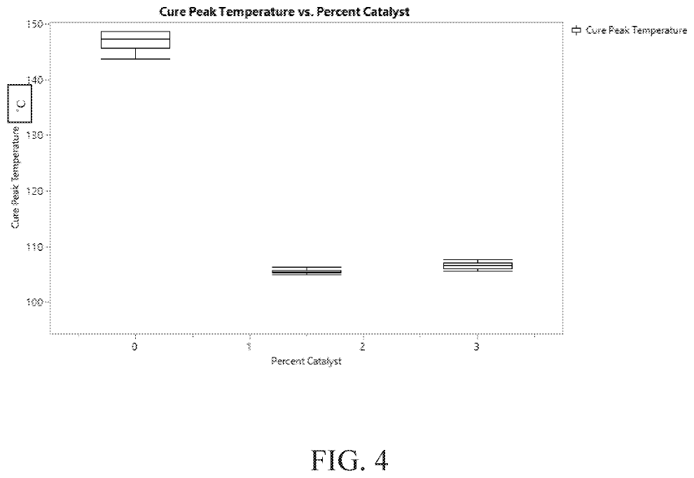

FIG. 4 illustrates the cure peak temperature versus percent catalyst loading. At higher catalyst levels, the cure reaction proceeds more rapidly and non-uniformly, leading to localized over-curing and reduced effective bond formation across the panel. The results establish that the appropriate catalyst loading for a given furnish is determined by its buffer capacity, and that applying an incorrect catalyst level produces failure modes that cannot be corrected through process adjustments such as increased press time.

Taken together, these results demonstrate two distinct regimes within the same low-buffer-capacity furnish: At low catalyst loading, cure is limited by reaction rate and can be improved by increased press time. At high catalyst loading, the cure becomes non-uniform, and increased press time does not restore performance.

For Douglas-fir furnish, which exhibits low buffer capacity, excessive catalyst loading (3.0 wt. %) results in over-rapid and spatially non-uniform curing. This leads to reduced IB and elevated variability, even when press time is extended. This represents an over-correction failure mode: a formulation condition appropriate for a higher-buffer-capacity furnish yields unacceptable performance when applied to a low-buffer-capacity wood.

Conversely, at low catalyst loading (0 wt. %), the system remains in a kinetically limited regime, where increased press time improves cure completeness and reduces variability. This demonstrates that cure behavior in this furnish is sensitive to both formulation and process conditions, but that process adjustments alone cannot compensate for incorrect formulation.

When considered alongside Example 1(b), in which a high-buffer-capacity furnish (e.g., white oak) exhibits high variability and unacceptable performance across all tested catalyst levels, these results define the operating window for a fixed formulation. The acceptable operating range of catalyst loading is narrower than the range of buffer-capacity variability observed across different furnish compositions. As a result, no single fixed formulation can produce acceptable performance across the full range of compositional conditions.

In continuous production, where furnish composition shifts during operation as species mix changes, the buffer capacity of the furnish will vary along the continuum shown in FIG. 2. The Douglas-fir condition evaluated here represents the low-buffer end of this range. As the system transitions toward higher-buffer-capacity furnish, the catalyst requirement increases. If catalyst loading remains fixed, the system will move between under-cured and over-cured regimes, producing the inconsistent outcomes demonstrated in this and the preceding example.

Although buffer capacity in this study was measured using offline laboratory methods, the relevant system state is accessible through in-process measurements. Near-infrared (NIR) spectroscopy of the furnish stream can provide real-time estimates of species composition and associated buffer capacity. In-line pH measurement of the adhesive-furnish mixture can directly reflect the buffering effect during blending. Additionally, the curing profile shown in FIG. 4 can be inferred from in-press measurements such as temperature rise or dielectric response, which track cure progression during pressing.

These results therefore demonstrate that buffer capacity determines the required catalyst loading for uniform adhesive cure, and that mismatches between furnish chemistry and formulation lead to failure modes that cannot be corrected through process adjustments alone.

### Example 3. Relationship Between Catalyst Loading and Internal Bond Variability

The present example evaluates how buffer capacity influences internal bond variability across catalyst loading conditions, demonstrating the consequences of applying a fixed formulation across compositional states.

Homogeneous particleboard panels were manufactured using Douglas-fir furnish (buffer capacity 0.71) and white oak furnish (buffer capacity 1.78). Adhesive catalyst loading varied across multiple levels.

Internal bond (IB) variability was quantified using the coefficient of variation (CV) for each condition. Mean IB and CV were evaluated to assess both performance and uniformity of bonding.

Douglas-fir panels exhibited low variability at lower catalyst loadings, with CV values in the range of approximately 0.06-0.12. As catalyst loading increased, CV values increased to approximately 0.20-0.24, indicating a loss of cure uniformity at higher catalyst levels.

In contrast, white oak panels exhibited substantially higher variability across all catalyst loadings, with CV values reaching approximately 0.49. No catalyst level tested produced both low variability and acceptable bonding performance for white oak furnish.

These results demonstrate two distinct failure behaviors: For low-buffer-capacity Douglas-fir, excessive catalyst loading increases variability, indicating non-uniform cure. For high-buffer-capacity white oak, insufficient effective acidity leads to persistently high variability, with no tested catalyst level achieving uniform bonding.

These results establish that internal bond variability is directly governed by furnish buffer capacity, which affects adhesive cure uniformity. These results further demonstrate that catalyst loading must be matched to this compositional property to achieve consistent bonding.

For Douglas-fir furnish, which exhibits low buffer capacity, higher catalyst loading produces an over-correction failure mode. The increased acidity accelerates cure non-uniformly across the mat, resulting in elevated variability despite otherwise favorable bonding conditions.

For white oak furnish, which exhibits high buffer capacity, the adhesive system experiences an under-correction failure mode. The buffering effect reduces the system's effective acidity, leading to delayed and spatially inconsistent curing. This results in high variability (CV up to 0.49) across all catalyst levels tested, demonstrating that a formulation calibrated for lower-buffer-capacity furnish cannot produce acceptable performance under high-buffer conditions.

Taken together, these results define the operating limits of a fixed formulation. The range of catalyst loading that produces acceptable variability for Douglas-fir does not extend to the buffer capacity exhibited by white oak. As a result, no single catalyst level can maintain both low variability and acceptable bonding performance across the compositional range represented by these furnishes.

In continuous production, where species mix shifts during operation, the furnish buffer capacity will vary along the continuum shown in FIG. 2. As the system transitions from low-buffer to high-buffer furnish, the required catalyst loading increases. If catalyst loading remains fixed, the system will move between over-cured and under-cured regimes, producing the variability observed in this example.

Although buffer capacity was measured offline in this study, the relevant system state is accessible through in-process measurements. Near-infrared (NIR) spectroscopy of the furnish stream can estimate species composition and correlate with buffer capacity. In-line pH measurement of the adhesive-furnish mixture can reflect buffering effects in real time. Additionally, cure behavior—manifested here as variability in internal bond—can be monitored indirectly through in-press measurements such as temperature rise or dielectric response, which reflect cure progression.

These results therefore demonstrate that buffer capacity determines the catalyst requirement for uniform bonding, and that failure to match formulation to this compositional property results in unacceptable variability.

### Example 4. Effect of Catalyst Loading on Moisture Resistance and Variability

Moisture resistance properties, including thickness swell (TS) and water absorption (WA), are determined by the completeness and uniformity of adhesive cure within the panel. Adhesive cure behavior is influenced by the chemical interaction between the adhesive system and the furnish, which is governed by buffer capacity.

Homogeneous particleboard panels were manufactured using Douglas-fir (buffer capacity of 0.71) and white oak furnish (buffer capacity of 1.78). Catalyst loading varied across multiple levels. Thickness swell (TS) and water absorption (WA) were measured for each condition according to ASTM D10437. Variability in these properties was quantified using the coefficient of variation (CV). Statistical analysis indicated significant dependence of WA (P-value<0.0001) and TS (P-value<0.001) on catalyst loading.

The Douglas-fir panels exhibited lower variability in TS and WA at reduced catalyst levels. As catalyst loading increased, both the mean values and the variability of TS and WA increased, indicating a degradation in moisture-resistance performance under higher catalyst loadings. The white oak panels exhibited greater overall variability in TS and WA across all catalyst levels, with a less consistent response to changes in catalyst loading. No catalyst level consistently produced low variability and optimal moisture-resistance performance for white oak furnish.

Accordingly, the results demonstrate: 1) for low-buffer-capacity furnish, excessive catalyst loading increases variability and reduces performance; and 2) for high-buffer-capacity furnish, variability remains elevated across catalyst levels, indicating incomplete or inconsistent cure.

The results further establish that moisture resistance and its variability are governed by furnish buffer capacity, which influences the completeness and uniformity of adhesive cure.

For Douglas-fir furnish, low buffer capacity allows effective cure at lower catalyst levels. Increasing catalyst loading produces an over-correction failure mode, in which accelerated and non-uniform cure leads to regions of over-and under-cured adhesive, increasing variability in TS and WA.

For white oak furnish, high buffer capacity reduces the effective acidity of the adhesive system, resulting in incomplete and spatially inconsistent curing. This under-correction failure mode results in elevated variability in moisture-resistance properties across all tested catalyst levels, demonstrating that a formulation calibrated for lower-buffer-capacity furnish cannot achieve consistent performance under high-buffer conditions.

These results further define the limits of a fixed formulation. The catalyst loading that yields optimal moisture resistance for low-buffer furnish degrades performance at higher loadings. At the same time, the same formulation fails to achieve a consistent cure in high buffer furnish. As a result, no single catalyst level produces consistent moisture resistance across the compositional range represented by these furnishes.

In continuous production, where species composition varies during operation, buffer capacity will shift along a continuum, as shown in FIG. 2. As this occurs, the required catalyst loading for uniform cure also shifts. If catalyst loading remains fixed, the system will transition between regimes of incomplete cure and over-rapid cure, producing the variability observed in this example.

Although buffer capacity was measured offline in this study, the relevant system state can be accessed through in-process measurements. NIR spectroscopy can provide real-time estimates of species composition and buffer capacity. In-line pH measurements can reflect the buffering effect during adhesive application. Additionally, cure completeness—manifested here as moisture resistance performance—can be monitored through in-press measurements such as temperature profiles or dielectric response.

These results therefore demonstrate that buffer capacity determines the catalyst requirement for consistent moisture resistance, and that mismatches between furnish chemistry and formulation produce variability that cannot be corrected through fixed processing conditions alone.

### Example 5. Continuous-Run Adaptive Control During a Shift in Furnish Composition

A continuous particleboard manufacturing line is operated with a wood furnish whose species composition changes during operation such that the furnish transitions from a predominantly Douglas-fir composition to a mixed Douglas-fir/white oak composition and then to a predominantly white oak composition. The transition causes the buffer capacity of the furnish to vary during the production run over a range bounded by the low-buffer-capacity and high-buffer-capacity states characterized in the preceding examples. A urea-formaldehyde adhesive is applied to the furnish and the furnish is consolidated under heat and pressure to form particleboard panels.

During operation, the furnish stream is monitored using one or more in-process measurement techniques configured to provide a direct measurement of buffer capacity or an indirect measurement indicative of buffer capacity. For instance, one measurement technique may include near-infrared spectroscopy of the furnish stream calibrated to furnish species composition and associated buffer capacity. Another measurement technique includes in-line pH measurement of an adhesive-furnish mixture. Another measurement technique includes one or more in-process cure indicators, such as dielectric response or press temperature profile, that provide feedback regarding cure progression during pressing. The measured values are provided to a control module configured to determine a target catalyst loading for the urea-formaldehyde adhesive based on the measured buffer-capacity state of the furnish.

At a first interval of the production run, the measured buffer-capacity state corresponds to the low-buffer-capacity regime represented by Douglas-fir furnish. In response, the control module determines a first target catalyst loading corresponding to a low-catalyst or no-added-catalyst formulation state. The determined formulation is implemented before the monitored furnish reaches the press so that subsequently produced panels are manufactured using the first target catalyst loading. As the production run continues and the measured furnish state shifts toward an intermediate mixed-species condition, the control module determines a second target catalyst loading greater than the first target catalyst loading and directs formulation-adjustment equipment to increase catalyst addition on a timescale effective to influence panels subsequently produced from the shifted furnish state. At a later interval, when the measured furnish state shifts further toward the high-buffer-capacity regime represented by white oak furnish, the control module determines a third target catalyst loading greater than the second target catalyst loading and implements the corresponding formulation adjustment.

The control module further determines whether a process-parameter adjustment is to be implemented in coordination with the formulation adjustment. For example, where a measured cure indicator shows that the adhesive system remains within a kinetically limited regime after a catalyst adjustment, the control module may determine a target process-parameter adjustment comprising an increase in press time, press temperature, or both. Where the measured buffer-capacity state indicates that a higher catalyst loading would move the system toward a non-uniform cure regime, the control module may maintain the catalyst loading within a predetermined range and instead determine a different process-parameter adjustment or a target feedstock adjustment. The target feedstock adjustment may include modifying a furnish source-blend ratio or applying a pH-modifying or buffering treatment to the furnish upstream of adhesive application.

A contemporaneous control run is performed using the same changing furnish stream and the same manufacturing line conditions, with the proviso that the adhesive is held at a fixed catalyst loading selected for the initial low-buffer-capacity furnish condition. Panels produced during the fixed-formulation control run would be expected to exhibit increasing variability in internal bond strength, thickness swell, water absorption, vertical density profile, or combinations thereof as the furnish composition shifts away from the initial condition. By contrast, panels produced during the adaptive run would be expected to maintain lower variability across the production run because the catalyst loading is adjusted in response to the measured buffer-capacity state of the furnish before the shifted furnish reaches the press. Acceptance criteria for the adaptive run may be defined in terms of maintaining internal bond strength within a predetermined target range and maintaining coefficient of variation below a predetermined threshold across successive production intervals.

This example illustrates that the relevant source of feedstock variability may be a compositional property of the furnish that changes during ongoing operation of a manufacturing line and that is not fully characterized by conventional physical measurements alone. The example further illustrates that a manufacturing system can use a direct measurement of buffer capacity or an indirect measurement indicative of buffer capacity to determine and implement a target formulation during ongoing production, and to determine and implement a coordinated process-parameter adjustment or feedstock adjustment, so that subsequently produced product remains more consistent despite variation in the furnish chemistry.

### Example 6. Adaptive Feedstock Adjustment in Response to Measured Furnish Chemistry

A continuous particleboard manufacturing line is operated using wood furnish supplied from a plurality of furnish sources having different compositional properties. A first furnish source includes a lower-buffer-capacity furnish representative of Douglas-fir-dominated material. A second furnish source includes a higher-buffer-capacity furnish representative of white-oak-dominated material. During operation, the relative contribution of the furnish sources to the furnish stream varies over time, causing the chemical state of the furnish presented to the adhesive application stage to shift during the production run. The varying furnish stream is contacted with a urea-formaldehyde adhesive and consolidated under heat and pressure to form particleboard panels.

During operation, the furnish stream is monitored using one or more measurement techniques configured to provide a direct measurement of a compositional property of the furnish or an indirect measurement indicative of that compositional property. For example, the measured property may include buffer capacity or an indirect indicator of buffer capacity, including near-infrared spectroscopy of the furnish stream, species-composition estimation, in-line pH measurement, or another measurement correlated with furnish chemistry. The measured values are provided to a control module configured to determine a target feedstock adjustment based on the measured furnish state.

At a first interval of the production run, the measured furnish state corresponds to a lower-buffer-capacity condition. In response, the control module determines that no feedstock correction is required and permits the furnish stream to continue at a first source-blend ratio. At a later interval, the measured furnish state shifts toward a higher-buffer-capacity condition as the relative contribution of the second furnish source increases. In response, the control module determines a target feedstock adjustment comprising modification of the furnish source-blend ratio so as to reduce the proportion of the higher-buffer-capacity furnish and increase the proportion of the lower-buffer-capacity furnish before the adjusted furnish reaches the adhesive application stage. The adjusted source-blend ratio may be selected to maintain the effective buffer-capacity state of the furnish within a target range associated with more uniform adhesive cure.

The target feedstock adjustment may additionally or alternatively include applying a feedstock treatment upstream of adhesive application. For example, when the measured furnish state indicates a shift toward a higher-buffer-capacity condition, the control module may determine a target feedstock adjustment comprising application of a pH-modifying agent, a buffering agent, or another chemical treatment to the furnish in an amount effective to alter the chemical environment encountered by the adhesive. In some aspects, the target feedstock adjustment comprises both a change in source-blend ratio and a chemical treatment of the furnish. The control module may determine that the measured furnish state can be brought within a target range through feedstock adjustment alone, without requiring a change in catalyst loading or press conditions.

In a comparative control run, the same variable furnish sources are processed while maintaining a fixed furnish source-blend ratio and without applying the adaptive feedstock adjustment. Under those conditions, the effective chemical state of the furnish would be expected to drift as the contribution of the higher-buffer-capacity furnish increases, producing increased variability in cure behavior and resulting panel properties. Panels produced during the fixed-feedstock run would be expected to exhibit increased variability in internal bond strength, thickness swell, water absorption, vertical density profile, or combinations thereof as compared with panels produced during the adaptive feedstock-adjustment run.

The adaptive feedstock-adjustment run is performed while maintaining the adhesive formulation substantially constant. Under such conditions, the example illustrates that adaptive modification of the feedstock itself can compensate for variability in furnish chemistry and improve consistency of subsequently produced product, even without contemporaneous adjustment of catalyst loading or press conditions. The feedstock adjustment can be coordinated with a formulation adjustment or a process-parameter adjustment when the measured furnish state indicates that feedstock adjustment alone is insufficient or less preferred.

This example illustrates that, in some manufacturing processes, the most effective response to an inherently variable feedstock is not limited to changing the formulation or changing process conditions, but can instead comprise changing the feedstock state presented to the process. The example further illustrates that a direct measurement of a compositional property of the feedstock, or an indirect measurement indicative of that compositional property, can be used to determine and implement a target feedstock adjustment during ongoing operation of the manufacturing line so that subsequently produced product remains more consistent despite variation in feedstock chemistry.

### Example 7. Adaptive Increase in PMDI Loading

In OSB production using southern yellow pine (SYP) flakes, the wood species may remain constant while the physical substrate state varies during the production run. Moisture content is one such feedstock-state variable. Because pMDI performance depends on the condition of the furnish to which it is applied, a fixed pMDI loading selected for one moisture state does not produce the same board response when the furnish moisture state shifts.

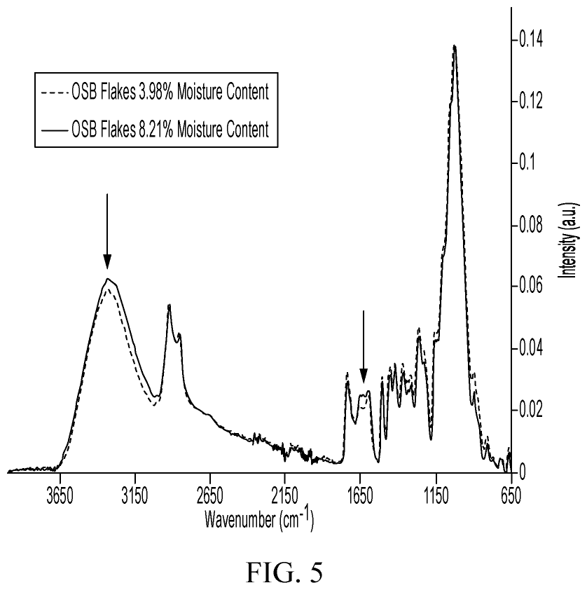

The adaptive manufacturing system therefore measures furnish moisture in line, for example by FT-IR, near IR, mid-IR, far-IR, FT-mIR, or the like, and uses that measured feedstock condition as a control input for pMDI loading. When the spectral measurement indicates a higher-moisture furnish state, the system increases pMDI loading from the lower-moisture baseline to restore board performance. FIG. 5 contains real-time spectral evidence distinguishing 4% and 8% moisture furnish, with water-associated peaks identifying the higher-moisture state that triggers the resin adjustment.

Homogeneous OSB panels with SYP flakes were prepared using a mixture of flake fines and long flakes as described. Moisture content was controlled to either 4.0%, as described. Panels were constructed at 14″×14″×0.4375″ (LWH) before being trimmed to 12″×12″×0.4375″. Panels were first treated with 1.0 wt. % of a slack wax emulsion in a large tumbler at roughly 21 °C and 40% relative humidity. Panels were consolidated at 425 °F with a press closure time of 40 seconds, press times of 60 seconds or 90 seconds as described, and a degassing time of 15 seconds. The target density of each specimen was 42 lb ft⁻³. Each sample condition was tested with 6 replicate boards, from which several testable specimens were collected for thickness swell, water absorption, D4, and internal bond strength.

At 4% moisture content, 1.2 wt. % pMDI, and 90 s press time, the panels exhibited mean water absorption of 18.97%, thickness swell of 15.21%, D4 of 742.25, internal bond strength of 33.56 psi, and 100% testable IBs. When mixed flake moisture content increased to 8% while pMDI loading and press time remained fixed at 1.2 wt. % and 90 s, water absorption increased to 25.32%, thickness swell increased to 19.96%, D4 decreased to 666.63, internal bond strength remained only 39.26 psi, and testable IBs fell to 81.08%. When the same 8% moisture furnish was instead bonded with 1.8 wt. % pMDI at 90 s, water absorption decreased to 18.56%, thickness swell decreased to 12.25%, D4 increased to 963.47, internal bond strength increased to 56.56 psi, and testable IBs increased to 89.19%.

The results demonstrate an explicit adaptive control loop. When the measured furnish condition shifts from 4% to 8% moisture, a fixed 1.2 wt. % pMDI setting becomes non-optimal, as shown by increased water absorption and thickness swell, reduced D4, and reduced percentage of testable IBs. In response to that measured higher-moisture state, the system increases pMDI loading to 1.8 wt. %, thereby restoring moisture resistance, increasing D4, improving internal bond, and reducing failing panels.

The failure of the fixed low-resin condition is not captured by IB alone, because the two 1.2 wt. % conditions produced similar IB values while moisture resistance and D4 deteriorated substantially at higher moisture. Accordingly, the measured system state for adaptation is not a single product metric, but the furnish moisture condition together with the resulting multi-property board response, including water absorption, thickness swell, D4, internal bond strength, and testable-IB yield as output feedback.

### Example 8. Feedstock Flake Form

In OSB manufacture, flake form is another substrate-state variable that changes during operation, particularly through variation in fines fraction, strand geometry, surface area, and size distribution. Even at constant species and moisture content, flake form changes the board response produced by a given pMDI loading.

The adaptive resin system therefore measures flake-form characteristics in line, for example by acquiring one or more images of the furnish and analyzing the images using image-analysis software, or by using a particle-characterization system or particle size analyzer. The measured flake-form state is then used to determine whether a lower or moderate pMDI loading remains viable or whether resin loading should be increased. In a reverse direction, the same measured flake-form data guides production toward an optimal furnish geometry and size distribution, where larger, more favorable flakes require less pMDI treatment and furnish preparation, such as sieving, reduces resin demand and cost.

Homogeneous OSB panels with SYP flakes were prepared using a mixture of flake fines and long flakes, compared to screened long flakes alone, as described. Moisture content was controlled to 4.0%. Panels were constructed at 14″×14″×0.4375″ (LWH) before being trimmed to 12″×12″×0.4375″. Panels were first treated with 1.0 wt. % of a slack wax emulsion in a large tumbler at roughly 21 °C and 40% relative humidity. Panels were consolidated at 425 °F with a press closure time of 40 seconds, press times of 60 seconds or 90 seconds as described, and a degassing time of 15 seconds. The target density of each specimen was 42 lb ft⁻³. Each sample condition was tested with 6 replicate boards, from which several testable specimens were collected for thickness swell, water absorption, D4, and internal bond strength.

At 4% moisture content and 60 s press time, long flakes outperformed mixed fine-and-long flakes at the same pMDI loading. At 1.2 wt. % pMDI, mixed flakes exhibited water absorption of 21.73%, thickness swell of 19.76%, D4 of 521.68, internal bond strength of 14.11 psi, and 36.11% testable IBs, whereas long flakes exhibited water absorption of 21.45%, thickness swell of 17.25%, D4 of 645.03, internal bond strength of 21.35 psi, and 100% testable IBs. At 1.8 wt. % pMDI, mixed flakes exhibited water absorption of 18.91%, thickness swell of 14.93%, D4 of 829.03, internal bond strength of 12.04 psi, and 16.67% testable IBs, whereas long flakes exhibited water absorption of 19.86%, thickness swell of 13.78%, D4 of 962.15, internal bond strength of 26.82 psi, and 86.11% testable IBs.

These results demonstrate a measurement-response-outcome relationship. When imaging or particle-size analysis identifies a more favorable long-flake, lower-fines substrate state at 4% moisture and 60 s press time, the system maintains a low or moderate pMDI loading rather than increasing resin in response to the poorer-performing mixed furnish. That measured feedstock condition leads to improved water absorption, lower thickness swell, higher D4, higher internal bond, and markedly improved testable-IB robustness at the same nominal resin levels.

Conversely, when the measured furnish shifts toward a fines-rich mixed-flake state, the same pMDI loading produces inferior results, demonstrating that flake-form measurement is a control input rather than a passive observation. The adaptive variable is therefore not limited to resin loading alone; substrate form itself determines whether a lower loading remains viable. The product measurements of water absorption, thickness swell, D4, internal bond strength, and testable-IB yield provide feedback confirming whether the selected loading remains acceptable for the measured flake form.

In a production system, a detected shift toward longer, less fines-rich furnish causes the system to maintain a lower or moderate resin loading rather than increasing resin in response to the poorer-performing mixed-flake condition. Stated differently, measured favorable flake form indicates that the lower loading remains viable, the system holds that loading, and the resulting board properties confirm the suitability of that response.

### Example 9. Maintenance of Stable Operating Window

An adaptive system does not merely identify failure; it also identifies operating windows in which board performance is retained despite expected variation in substrate state during continuous production. In such an operating window, the adaptive system measures the furnish condition, determines that the measured condition lies within a validated retained-performance range, and maintains the selected resin setpoint rather than unnecessarily escalating treatment.

Homogeneous OSB panels with SYP flakes were prepared using a mixture of flake fines and long flakes. Moisture content was controlled to either 4.0% or 8.0%, as described. Panels were constructed at 14″×14″×0.4375″ (LWH) before being trimmed to 12″×12″×0.4375″. Panels were first treated with 1.0 wt. % of a slack wax emulsion in a large tumbler at roughly 21 °C and 40% relative humidity. Panels were consolidated at 425 °F with a press closure time of 40 seconds, press times of 60 seconds or 90 seconds as described, and a degassing time of 15 seconds. The target density of each specimen was 42 lb ft⁻³. Each sample condition was tested with 6 replicate boards, from which several testable specimens were collected for thickness swell, water absorption, D4, and internal bond strength.

For mixed fine-and-long SYP flakes bonded with 1.8 wt. % pMDI and pressed for 90 s, the board response remained substantially stable across furnish moisture contents of 4% and 8%. At 4% moisture, mean water absorption was 17.28%, thickness swell was 10.60%, D4 was 1044.67, internal bond strength was 59.19 psi, and testable IBs were 83.33%. At 8% moisture, mean water absorption was 18.56%, thickness swell was 12.25%, D4 was 963.47, internal bond strength was 56.56 psi, and testable IBs were 89.19%. Both sets of 4% and 8% moisture content values were within the standard deviation margin of one another.

These results demonstrate a retained-performance operating window at 1.8 wt. % pMDI and 90 s press time for mixed-flake OSB across the tested 4-8% moisture range. When the moisture measurement places the furnish within this range, the system recognizes that the current 1.8 wt. % pMDI setting remains sufficient and maintains that loading rather than escalating to the highest resin loading.

The resulting output remains substantially stable, as shown by the closely grouped values for water absorption, thickness swell, D4, internal bond strength, and testable-IB yield at 4% and 8% moisture. This is a strong adaptive-manufacturing example because it defines a demonstrated response function, not merely a theoretical one: measured moisture within the validated operating window causes the system to hold the existing resin setpoint, and the resulting board properties confirm retained performance without requiring further correction.

### Example 10. Increased pMDI Loading

Homogeneous OSB panels with SYP flakes were prepared using screened long flakes, as described. Moisture content was controlled to 4.0%, as described. Panels were constructed at 14″×14″×0.4375″ (LWH) before being trimmed to 12″×12″×0.4375″. Panels were first treated with 1.0 wt. % of a slack wax emulsion in a large tumbler at roughly 21 °C and 40% relative humidity. Panels were consolidated at 425 °F with a press closure time of 40 seconds, press times of 60 seconds or 90 seconds as described, and a degassing time of 15 seconds. The target density of each specimen was 42 lb ft⁻³. Each sample condition was tested with 6 replicate boards, from which several testable specimens were collected for thickness swell, water absorption, D4, and internal bond strength.

For long flakes at 4% moisture content and 5.0 wt. % pMDI, reducing press time from 90 s to 60 s produced a severe loss in bond performance. At 60 s, water absorption was 13.44%, thickness swell was 8.17%, D4 was 1332.07, internal bond strength was only 4.84 psi, and testable IBs were only 11.11%. At 90 s, the same furnish and resin loading produced water absorption of 11.83%, thickness swell of 6.26%, D4 of 1641.64, internal bond strength of 117.01 psi, and 83.33% testable IBs.

The results demonstrate that a high pMDI loading does not, by itself, guarantee acceptable bonding at a shortened press time. When the measured process condition shifts to a 60 s press schedule under the tested long-flake, 4% moisture, 5.0 wt. % pMDI state, the resulting board response shows a severe collapse in internal bond strength and testable-IB specimen yield, even though some moisture-related properties remain relatively low.

Accordingly, press time functions as an independent process boundary in the adaptive system. If the system detects a shortened press schedule of this type, it does not treat higher resin loading as a substitute for adequate pressing. The 60 s condition is therefore an explicit non-adaptive failure case, and the demonstrated adaptive conclusion is that the system maintains or restores adequate press time because restoring press time to 90 s produces the improved bond performance shown by the data. The output feedback confirms that boundary includes at least internal bond strength and testable-IB yield, rather than moisture-related properties alone.

### Example 11. Coordinated Adaptive Response

Homogeneous OSB panels with SYP flakes were prepared using a mixture of flake fines and long flakes, as described. Moisture content was controlled to 4.0%, as described. Panels were constructed at 14″×14″×0.4375″ (LWH) before being trimmed to 12″×12″×0.4375″. Panels were first treated with 1.0 wt. % of a slack wax emulsion in a large tumbler at roughly 21 °C and 40% relative humidity. Panels were consolidated at 425 °F with a press closure time of 40 seconds, press times of 60 seconds or 90 seconds as described, and a degassing time of 15 seconds. The target density of each specimen was 42 lb ft⁻³. Each sample condition was tested with 6 replicate boards, from which several testable specimens were collected for thickness swell, water absorption, D4, and internal bond strength.

For mixed fine-and-long flakes at 4% moisture content and 60 s press time, increasing pMDI loading from 1.2 wt. % to 1.8 wt. % improved water absorption, thickness swell, and D4, but did not improve bond robustness. At 1.2 wt. %, water absorption was 21.73%, thickness swell was 19.76%, D4 was 521.68, internal bond strength was 14.11 psi, and testable IBs were 36.11%. At 1.8 wt. %, water absorption decreased to 18.91%, thickness swell decreased to 14.93%, and D4 increased to 829.03, but internal bond strength remained only 12.04 psi and testable IBs decreased to 16.67%. Increasing pMDI further to 5.0 wt. % at 60 s improved water absorption to 15.94%, thickness swell to 8.75%, D4 to 1163.55, and internal bond to 41.85 psi, but testable IBs remained only 30.56%. By contrast, at the same 4% moisture condition, 1.8 wt. % pMDI and 90 s press time produced internal bond strength of 59.19 psi and 83.33% testable IBs.

The results demonstrate that, for dry mixed furnish under a shortened 60 s press schedule, a modest increase from 1.2 wt. % to 1.8 wt. % pMDI is not an adequate adaptive response when bond robustness is a target. The measured state here is not moisture alone; rather, it is the combined condition of dry mixed furnish, fines-containing geometry, and short press time.

When that measured feedstock/process state is present, the system recognizes that a small resin increase improves some output metrics, including water absorption, thickness swell, and D4, but fails to restore internal bond strength and testable-IB specimen yield. In response to that measured condition, the data define two more effective adaptive responses: either maintain or restore a longer press time or escalate resin loading more substantially. Even then, the results show that shorter press time remains a significant process limitation.

### Example 12. Performance Margin

Adaptive response is not only about rescuing a failing condition, but also about choosing between sufficient loading and a maximum-margin loading once the substrate state is known. For a given measured feedstock deviation, the system may select a first loading that retains performance at lower cost or a second, higher loading that provides additional performance margin, depending on the operating objective.

Homogeneous OSB panels with SYP flakes were prepared using a mixture of flake fines and long flakes, as described. Moisture content was controlled to 8.0%, as described. Panels were constructed at 14″×14″×0.4375″ (LWH) before being trimmed to 12″×12″×0.4375″. Panels were first treated with 1.0 wt. % of a slack wax emulsion in a large tumbler at roughly 21 °C and 40% relative humidity. Panels were consolidated at 425 °F with a press closure time of 40 seconds, press times of 60 seconds or 90 seconds as described, and a degassing time of 15 seconds. The target density of each specimen was 42 lb ft⁻³. Each sample condition was tested with 6 replicate boards, from which several testable specimens were collected for thickness swell, water absorption, D4, and internal bond strength.

For mixed fine-and-long flakes at 8% moisture content and 90 s press time, 1.8 wt. % pMDI produced water absorption of 18.56%, thickness swell of 12.25%, D4 of 963.47, internal bond strength of 56.56 psi, and 89.19% testable IBs. Under the same substrate and press condition, increasing pMDI to 5.0 wt. % produced water absorption of 13.00%, thickness swell of 7.12%, D4 of 1819.99, internal bond strength of 111.77 psi, and 97.30% testable IBs.

These results define two demonstrated adaptive responses for the same high-moisture substrate state. When the system measures mixed furnish at 8% moisture content and a 90 s press time, it can select 1.8 wt. % pMDI to retain substantially stable performance, or it can select 5.0 wt. % pMDI to achieve a larger property margin. The measured feedstock condition is therefore the same in both cases, but the selected control response differs according to operating objective.

The resulting output confirms that distinction: 1.8 wt. % maintains strong performance, whereas 5.0 wt. % further lowers water absorption and thickness swell and further increases D4, internal bond strength, and testable-IB yield. Accordingly, once the higher-moisture state is detected, the response function is not merely “increase resin,” but “increase resin to the level appropriate for the desired operating objective,” whether that objective is retained performance at lower cost or maximum property margin. The product measurements serve as feedback confirming whether the selected loading is sufficient or whether additional margin has been achieved.

The terminology used here serves to explain, not to limit, the invention. Unless a specific context demands otherwise, singular terms should be read to include their plural forms and vice versa, and the articles “a,” “an,” and “the” are interchangeable with “at least one.” The verbs “include” and “including” are intended to be open-ended in the same way “comprise” and “comprising” are interpreted in patent claims. Likewise, the conjunction “or” should be understood as “A or B or both,” unless the text expressly says, “only A or B, but not both.” Unless the context states otherwise, any set of process steps described here can be carried out in any order. All numerical values—amounts, temperatures, pressures, and so on—are to be taken as “about” those numbers, interpreted in light of significant digits and ordinary rounding. A stated range such as “1 to 10” covers every sub-range and individual value between 1 and 10, for example 1 to 6.1 or 2.3 to 9.4, as well as each integer from 1 through 10. Each expression of the invention described here (e.g., method, composition, apparatus) may comprise, consist essentially of, or consist of the elements set out in this disclosure together with any optional features useful in an invention or in any preferred or derived embodiment.

1. A method of manufacturing a product from an inherently variable feedstock, the method comprising the steps of:
introducing an inherently variable feedstock into an industrial process, the inherently variable feedstock exhibiting variation in composition over time;
measuring, in real time during operation of the industrial process, at least one of a feedstock property, a process condition, or a product property,
determining, based on the at least one measured feedstock property, process condition, or product property, at least one of a target formulation, a target process parameter adjustment, or a target feedstock adjustment; and
implementing at least one of the target formulation, the target process parameter adjustment, or the target feedstock adjustment during ongoing operation of the industrial process, in a time frame effective to influence the subsequently produced product.

2. The method of claim 1, wherein the at least one feedstock property comprises a compositional property of the feedstock that is indicative of the feedstock's chemical composition, species identity, anatomy, age, extractive content, buffer capacity, or combinations thereof, and wherein the compositional property is not fully characterized by physical measurements of temperature or moisture content alone.

3. The method of claim 1, wherein measuring includes measuring at least two of a feedstock property, a process condition, or a product property.

4. The method of claim 1, wherein the measuring step includes measuring a feedstock property, and one or more of a process condition or a product property.

5. The method of claim 1, wherein the at least one measured feedstock property, process condition, or product property comprises a direct measurement or an indirect measurement indicative of feedstock condition, process behavior, or product performance.

6. The method of claim 1, wherein the step of determining at least one of the target formulation, target process parameter adjustment, or the target feedstock adjustment comprises using an upstream measurement to provide a coordinated feedforward adjustment and using a downstream measurement to provide a coordinated feedback adjustment.

7. The method of claim 1, further comprising providing the at least one measured feedstock property, process condition, or product property to a control module.

8. The method of claim 7, wherein the control module operates in a coordinated feedforward-and-feedback mode in which an upstream measurement provides an anticipatory adjustment and a downstream measurement provides a corrective adjustment.

9. The method of claim 1, wherein the method supplies a formulation to the industrial process and the implementation step implements a target formulation, the method further including the steps of:
adjusting the formulation supplied to the industrial process in real time to achieve the target formulation to form an adjusted formulation;
contacting the inherently variable feedstock with the adjusted formulation; and
processing the inherently variable feedstock with the adjusted formulation to produce the product.

10. The method of claim 9, wherein the target formulation is achieved by adjusting one or more formulation ingredients at or near a point of use from a plurality of standardized components.

11. The method of claim 10, wherein the plurality of standardized components comprises a first standardized adhesive composition comprising a higher-average-molecular-weight resin fraction and a second standardized adhesive composition comprising a lower-average-molecular-weight resin fraction.

12. The method of claim 11, wherein the target formulation is achieved by blending the first standardized adhesive composition and the second standardized adhesive composition in a blend ratio determined from the at least one measured feedstock property, process condition, or product property.

13. The method of claim 1, comprising a target process parameter adjustment of adjusting one or more operating parameters selected from the group consisting of temperature, pressure, line speed, residence time, application rate, mixing intensity, curing conditions, drying conditions, moisture target, and combinations thereof.

14. The method of claim 1, comprising a target feedstock adjustment of moisture conditioning, source selection, source blending, pre-treatment application, or a combination thereof implemented at or upstream of a point of contact between the feedstock and the formulation.

15. The method of claim 1, wherein the implementing step comprises implementing at least two of the target formulation, the target process parameter adjustment, and the target feedstock adjustment in coordination with one another.

16. The method of claim 1, wherein the industrial process is a glass manufacturing process, a wood product manufacturing process, a cement manufacturing process, a ceramic manufacturing process, a pulp-and-paper manufacturing process, a polymer manufacturing process, a composite manufacturing process, a food manufacturing process, a pharmaceutical manufacturing process, a chemical treatment process, an insulation manufacturing process, a laminate manufacturing process, an industrial fluid process, an additive-delivery process, a battery manufacturing process, or a water-treatment process.

17. A system for adaptively controlling an industrial process in which an inherently variable feedstock is contacted with a formulation to produce a product, the system comprising:
one or more measurement devices configured to measure at least one of a feedstock property, a process condition, or a product property during operation of the industrial process;
a control module configured to receive the at least one measured feedstock property, process condition, or product property and to determine, based thereon, at least one of a target formulation, a target process parameter adjustment, or a target feedstock adjustment;
formulation-adjustment equipment configured to implement the target formulation;
process control equipment configured to implement the target process parameter adjustment; and
feedstock-adjustment equipment configured to implement the target feedstock adjustment during operation of the industrial process.

18. The system of claim 17, wherein the control module is configured to receive measured data from the one or more measurement devices and to normalize, timestamp, correlate, and transform the measured data into control-relevant features.

19. The system of claim 17, wherein the control module is configured to determine the target formulation, the target process parameter adjustment, or the target feedstock adjustment by selecting a validated control state from a plurality of validated control states or by interpolating between validated control states, each validated control state being within a validated operating range.

20. The system of claim 17, wherein the system is implemented as a distributed platform in which time-sensitive control functions are executed locally and longer-horizon learning or optimization functions are executed remotely or in a hybrid computing environment.

21. The system of claim 17, wherein the industrial process comprises the manufacture of an engineered wood product and the one or more measurement devices are positioned along an engineered wood production line to measure furnish moisture content, adhesive gel time, mat moisture content, dielectric response, panel thickness, internal bond strength, thickness swell, emissions, water absorption, water resistance, density, density profile, screw holding capacity, particle geometry, delamination resistance, thickness, thickness variation, defects, modulus of rupture, modulus of elasticity, mat weight, mat uniformity, particle size distribution, and combinations thereof.

22. The system of claim 21, wherein the control module is configured to direct different target formulations, different target feedstock adjustments, different target process parameter adjustments, or combinations thereof to face layers and interior layers so as to provide a zoned or gradient product architecture.

23. The system of claim 17, wherein the feedstock-adjustment equipment comprises one or more of dryers, humidifiers, classifiers, screens, refiners, source-selection devices, routing devices, blend conveyors, or pre-treatment applicators.

24. A method of manufacturing an engineered wood product from an inherently variable wood furnish and a wood adhesive, the method comprising:
introducing a wood furnish into a manufacturing process;
measuring, in real-time during operation, at least one of furnish moisture content, furnish extractives indicator, furnish pH, furnish buffer capacity, adhesive gel time, mat moisture content at press entry, dielectric response, density profile, internal bond strength, thickness swell, water absorption, emissions, water resistance, density, screw holding capacity, particle geometry, delamination resistance, thickness, thickness variation, defects, modulus of rupture, modulus of elasticity, mat weight, mat uniformity, and particle size distribution to provide at least one measured value;
determining, based on the at least one measured value, at least one of a target wood adhesive, a target press parameter adjustment, or a target wood furnish adjustment;
implementing at least one of the target wood adhesive, the target press parameter adjustment, or the target wood furnish adjustment during operation of the manufacturing process;
contacting the wood furnish with the wood adhesive; and
consolidating the wood furnish and the wood adhesive under heat and pressure to produce the engineered wood product.

25. The method of claim 24, wherein the at least one measured value comprises adhesive gel time and the target wood furnish adjustment comprises adjusting a blend ratio between wood furnish from at least two bins or sources having different pH or extractives content.

26. The method of claim 24, wherein the at least one measured value comprises thickness swell exceeding a target threshold and the target wood furnish adjustment comprises lowering a furnish moisture target by reducing a dryer discharge moisture target.

27. The method of claim 24, wherein the target wood furnish adjustment comprises applying a pH-modifying agent or a buffering agent to the wood furnish in a dosage determined from the at least one measured value.

28. The method of claim 24, wherein the method further comprises adjusting the wood adhesive in real time to achieve the target wood adhesive.
